(19) United States
(12) Patent Application Publication
(10) Pub. No.: US 2025/0340805 A1
(43) Pub. Date: Nov. 6, 2025

(54) BEER-TASTE WORT

(71) Applicant: SUNTORY HOLDINGS LIMITED, Osaka-shi, Osaka (JP)

(72) Inventors: Yuichi Kato, Fuchu-shi (JP); Takaho Okajima, Fuchu-shi (JP)

(73) Assignee: SUNTORY HOLDINGS LIMITED, Osaka-shi, Osaka (JP)

(21) Appl. No.: 18/868,900

(22) PCT Filed: May 30, 2023
(86) PCT No.: PCT/JP2023/020133

§ 371 Date: Nov. 25, 2024

(30) Foreign Application Priority Data
May 31, 2022 (JP) 2022-088743

(51) Int. Cl. C12C 7/20; C12C 7/26; C12C 7/28

(52) U.S. Cl. CPC C12C 7/205; C12C 7/26; C12C 7/282; C12C 2200/35

(57) ABSTRACT

There is a demand for a beer-taste wort having less grain odor. The beer-taste wort has a ratio ((B)/(A)) of an original extract concentration (unit: mass %) (B) to an alcohol content (unit: (v/v) %) (A) of 2.50 or less.

### TECHNICAL FIELD

The present invention relates to a beer-taste wort.

### BACKGROUND ART

There have been known methods and apparatus to mix malt-based wort, carbonated water and the like and thereby producing beer beverages.

For example, Patent Document 1 discloses a method for producing beer beverage and an appliance for dispensing beer beverage, by which a malt-based fermented beverage concentrate and a carbonated liquid diluent are mixed to produce malt based fermented beverage.

### CITATION LIST

### Patent Document

Patent Document 1: WO 2018/100071

### SUMMARY OF INVENTION

### Technical Problem

A beer-taste wort such as a malt-based wort, which is to be diluted, is designed to have a higher alcohol content and a higher original extract concentration as compared with a normal beer-taste beverage. However, a lack of balance between the two has tended to increase an unsuitable grain odor derived from malt. Therefore, there is a demand for a beer-taste wort from which such an unsuitable grain odor is reduced. There is also a demand that when diluted, a beer-taste wort enables production of a beer-taste beverage excellent in full-bodied, refreshing, crisp, and stimulating tastes.

### Solution to Problem

The present invention provides a beer-taste wort having a ratio of an original extract concentration to an alcohol content adjusted within a predetermined range and to be diluted for consumption.

That is, the present invention includes the following aspects.
[1]

A beer-taste wort, having a ratio ((B)/(A)) of an original extract concentration (in mass %) (B) to an alcohol content (in (v/v) %) (A) of 2.50 or less.
[2]

The beer-taste wort according to [1], wherein the original extract concentration is 15.0 mass % or more and 50.0 mass % or less.
[3]

The beer-taste wort according to [1] or [2], wherein the alcohol content is 8.00 (v/v) % or more.
[4]

The beer-taste wort according to any one of [1] to [3], wherein the alcohol content is 50.00 (v/v) % or less.
[5]

The beer-taste wort according to any one of [1] to [4], wherein a malt ratio of the beer-taste wort is 30 mass % or more.
[6]

The beer-taste wort according to any one of [1] to [5], wherein a total nitrogen amount of the beer-taste wort is 45 mg/100 mL or more.
[7]

The beer-taste wort according to any one of [1] to [6], wherein a total polyphenol amount of the beer-taste wort is 500 ppm by mass or less.
[8]

The beer-taste wort according to any one of [1] to [7], wherein a free amino nitrogen content of the beer-taste wort is 40 mg/100 mL or less.
[9]

The beer-taste wort according to any one of [1] to [8], wherein a phosphoric acid content of the beer-taste wort is 350 mg/L or more.

The beer-taste wort according to any one of [1] to [9], which is a wort to be diluted by a factor of 2 or more and 10 or less.

The beer-taste wort according to any one of [1] to [10], which is a fermentation wort.

The beer-taste wort according to any one of [1] to [11], including no spirits.

The beer-taste wort according to any one of [1] to [12], wherein an invertase activity value of the beer-taste wort is 55 units or less.

The beer-taste wort according to any one of [1] to [12], wherein an invertase activity value of the beer-taste wort is more than 55 units.

A beer-taste beverage containing the beer-taste wort described in any one of [1] to [14] and an edible aqueous solution.

A beer-taste beverage produced by mixing an edible aqueous solution with the beer-taste wort described in any one of [1] to [14].

A production method for the beer-taste wort described in any one of [1] to [14], the method including adding an enzyme.

The production method according to [17], further including heat-treating a beer-taste wort.

### Advantageous Effects of Invention

According to a preferred aspect of the present invention, there is provided a beer-taste wort having a reduced unsuitable grain odor. According to a preferred aspect of the present invention, there is also provided a beer-taste wort which is diluted to prepare a beer-taste beverage excellent in full-bodied, refreshing, crisp, and stimulating tastes.

### DESCRIPTION OF EMBODIMENTS

For numerical ranges described in the present specification, upper and lower limit values can be freely combined. For example, in a case where a numerical range is described as “preferably (from) 3.0 to 15, and more preferably (from) 3.2 to 13”, a range of “(from) 3.0 to 13” and a range of “(from) 3.2 to 15” are also included in the numerical range described herein. Furthermore, for example, in a case where a numerical range is described as “preferably 30 or more, more preferably 40 or more, and preferably 100 or less, more preferably 80 or less”, a range of “(from) 30 to 80” and a range of “(from) 40 to 100” are also included in the numerical range described herein.

Moreover, for example, the numerical range of “(from) 60 to 100” described herein means a range of “60 or more (60 or more than 60) and 100 or less (100 or less than 100)”.

Furthermore, in the definitions of the upper limit values and the lower limit values described herein, numerical values can be appropriately selected from respective options and freely combined to define numerical ranges of from lower limit values to upper limit values.

In addition, a plurality of various requirements described as preferred aspects described in the present specification can be combined.

### 1. Beer-Taste Wort

As used herein, the term “beer-taste wort” refers to an edible solution which is mixed with an edible aqueous solution to produce a beer-taste beverage, and is not a solution intended for direct consumption. The beer-taste wort is not particularly limited as long as it is a liquid that can be mixed with an edible aqueous solution to produce a beer-taste beverage. A beer-taste wort according to one aspect of the present invention is intended to be mixed with an edible aqueous solution and thereby diluting the beer-taste wort, and hence the alcohol content, the original extract concentration, the content concentration of aroma components (esters, higher alcohols, etc.), the chromaticity, the bitterness units, and the like thereof tend to be higher than those of typical beer-taste beverages, but may be the same level as those of typical beer-taste beverages.

As used herein, the term “beer-taste beverage” refers to an alcohol-containing carbonated beverage with a beer-like flavor. That is, unless otherwise specified, the beer-taste beverage as used herein encompasses any carbonated beverage with a flavor of beer. As the beer-taste beverage according to one aspect of the present invention, examples that may be mentioned includes one that contains the beer-taste wort according to one aspect of the present invention and an edible aqueous solution. Also, examples of the beer-taste beverage according to one aspect of the present invention include a beer-taste beverage prepared by mixing the beer-taste wort according to one aspect of the present invention with an edible aqueous solution.

As used herein, the term “edible aqueous solution” refers to a solution in which one or more edible components are dissolved in water. The edible component is not particularly limited, and may be a solid such as ice or dry ice, a liquid such as vegetable oil, alcoholic liquors containing alcohol, or fruit juice, or a gas such as carbon dioxide gas or nitrogen gas.

The edible aqueous solution to be mixed with the beer-taste wort according to the present invention is not particularly limited, and examples thereof include sparkling aqueous solutions such as soda pop, Japanese lemonade, cola, carbonated water, chu-hi (shochu mixed with soda water), hard seltzer, highball (whisky mixed with soda water), non-alcohol beer-taste beverages, cider and champagne, and non-sparkling aqueous solutions such as soft drinks, teas, black teas, coffees, sake, shochu, wines, fruit liquor, gin, vodka, whisky, rum, brandy, tequila and flavor-containing syrups (including concentrates), but a sparkling aqueous solution is preferable, an aqueous solution that contains carbonic acid is more preferable, a carbonated beverage is more preferable, and carbonated water is particularly preferable.

The carbon dioxide gas concentration in the edible aqueous solution of the present invention is preferably 0.30 (w/w) % or more, more preferably 0.35 (w/w) % or more, still more preferably 0.40 (w/w) % or more, even more preferably 0.42 (w/w) % or more, particularly preferably 0.45 (w/w) % or more, and is preferably 0.90 (w/w) % or less, and may be 0.80 (w/w) % or less, 0.70 (w/w) % or less, 0.6 (w/w) or less, or 0.55 (w/w) % or less.

Note that, in the present specification, the carbon dioxide gas concentration can be measured in a process in which a container that contains a target beverage is immersed in a water tank at 20° C. for 30 minutes or longer with being shaken from time to time so that the temperature of the beverage becomes 20° C. and then the concentration is measured with a gas volume analyzer (e.g., GVA-500 (available from Kyoto Electronics Manufacturing Co., Ltd.) etc.).

The beer-taste wort encompasses not only a malt fermentation wort that is obtained by using malt, hops, and water as raw materials and fermenting them with yeasts, but also an original liquid added with a beer flavor that contains an ester, a higher alcohol, a lactone, or the like. The beer-taste wort may be a carbonic acid-containing wort that contains carbonic acid, or may be a carbonic acid-free wort that does not contain carbonic acid. Note that the raw materials of the beer-taste wort are not limited to those described above, and sugars, corn grits, or the like, for example, may be used as the raw materials as described below.

Examples of the beer flavor include isoamyl acetate, ethyl acetate, n-propanol (such as 1-propanol), isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methylbutyrate, ethyl n-butyrate, myrcene, citral, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranyl acetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3 (2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, B-eudesmol, 4-mercapto-4-methylpentane-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, phenethyl alcohol, nerol, citronellol, methyl p-toluate, 1,2,3,5-tetramethylbenzene, triethyl citrate, tributyl citrate, diethyl tartrate, dibutyl malate, perillaldehyde, methylheptenone, lemon myrtle, and cinnamaldehyde.

In addition, the beer-taste wort according to one aspect of the present invention may be a fermented beer-taste wort that has been produced through a fermentation step with yeasts, or may be a non-fermented beer-taste wort that has been produced without any fermentation step.

The fermented beer-taste wort may be an ale beer-taste wort brewed through a fermentation step with top-fermenting yeasts (Saccharomyces etc.), may be a lager beer-taste wort brewed through a fermentation step with bottom-fermenting yeasts (Saccharomyces etc.), may be a pilsner beer-taste wort, or may be a blend of these beer-taste wort. The term “fermentation” as used herein may be alcoholic fermentation that produces alcohol, or may be non-alcoholic fermentation that does not produce alcohol.

In addition, the beer-taste wort according to one aspect of the present invention may be a malt-used beer-taste wort using malt (such as barley malt, wheat malt, etc.) as a raw material, or may be a malt-free beer-taste wort without using malt. Examples of the malt-used beer-taste wort include barley malt-used beer-taste wort.

The beer-taste wort according to one aspect of the present invention is adjusted to have a ratio of an original extract concentration to an alcohol content within a predetermined range. The present inventors have found that these ratios are adjusted to be within a predetermined range and thereby reducing an unsuitable grain odor derived from cereal grain raw materials such as malt.

That is, the beer-taste wort according to one aspect of the present invention has a ratio [(B)/(A)] of the original extract concentration (in mass %) (B) to the alcohol content (in (v/v) %) (A) of 2.50 or less, but from the point of view set forth above, the ratio is preferably 2.48 or less, 2.46 or less, more preferably 2.44 or less, 2.42 or less, further preferably 2.40 or less, 2.38 or less, still more preferably 2.36 or less, 2.34 or less, and particularly preferably 2.32 or less, or 2.30 or less, and may be 2.28 or less, 2.26 or less, 2.24 or less, 2.22 or less, 2.20 or less, 2.18 or less, 2.16 or less, 2.14 or less, 2.12 or less, 2.10 or less, 2.08 or less, 2.06 or less, 2.04 or less, 2.02 or less, 2.00 or less, 1.98 or less, 1.96 or less, 1.94 or less, 1.92 or less, 1.90 or less, 1.88 or less, 1.86 or less, 1.84 or less, 1.82 or less, 1.80 or less, 1.78 or less, 1.76 or less, 1.74 or less, 1.72 or less, 1.70 or less, 1.68 or less, 1.66 or less, 1.64 or less, 1.62 or less, 1.60 or less, 1.58 or less, 1.56 or less, 1.54 or less, 1.52 or less, or 1.50 or less.

Moreover, the ratio [(B)/(A)] of the original extract concentration (in mass %) (B) to the alcohol content (in (v/v) %) (A) of the beer-taste wort may be 1.20 or more, 1.25 or more, 1.30 or more, 1.35 or more, 1.40 or more, 1.45 or more, or 1.50 or more from a point of view of making a wort for producing a beer-taste beverage that has a good taste and tastes like beer.

The alcohol content (ethanol content (v/v) %) of the beer-taste wort according to one aspect of the present invention may be more than 0.0 (v/v) %, 0.1 (v/v) % or more, 0.3 (v/v) % or more, 0.5 (v/v) % or more, 0.7 (v/v) % or more, 1.0 (v/v) % or more, 2.0 (v/v) % or more, 3.0 (v/v) % or more, 3.5 (v/v) % or more, 4.0 (v/v) % or more, 4.5 (v/v) % or more, 5.0 (v/v) % or more, 5.5 (v/v) % or more, 6.0 (v/v) % or more, 6.5 (v/v) % or more, or 7.0 (v/v) % or more, but from a point of view of a full-bodied taste, it is preferably 8.0 (v/v) % or more, more preferably 8.5 (v/v) % or more, more preferably 9.0 (v/v) % or more, more preferably 9.5 (v/v) % or more, more preferably 10.0 (v/v) % or more, more preferably 10.5 (v/v) % or more, more preferably 11.0 (v/v) % or more, and furthermore it may be 11.5 (v/v) % or more, 12.0 (v/v) % or more, 12.5 (v/v) % or more, 13.0 (v/v) % or more, 13.5 (v/v) % or more, 14.0 (v/v) % or more, 14.5 (v/v) % or more, 15.0 (v/v) % or more, 15.5 (v/v) % or more, 16.0 (v/v) % or more, 16.5 (v/v) % or more, 17.0 (v/v) % or more, 17.5 (v/v) % or more, 18.0 (v/v) % or more, 18.5 (v/v) % or more, 19.0 (v/v) % or more, 19.5 (v/v) % or more, 20.0 (v/v) % or more, 21.0 (v/v) % or more, 22.0 (v/v) % or more, 23.0 (v/v) % or more, 24.0 (v/v) % or more, or 25.0 (v/v) % or more.

The alcohol content of the beer-taste wort may be 50.0 (v/v) % or less, 45.0 (v/v) % or less, 35.0 (v/v) % or less, 30.0 (v/v) % or less, less than 25.0 (v/v) %, 24.0 (v/v) % or less, 23.0 (v/v) % or less, 22.0 (v/v) % or less, 21.0 (v/v) % or less, 20.0 (v/v) % or less, 19.5 (v/v) % or less, 19.0 (v/v) % or less, 18.5 (v/v) % or less, 18.0 (v/v) % or less, 17.5 (v/v) % or less, 17.0 (v/v) % or less, 16.5 (v/v) % or less, 16.0 (v/v) % or less, 15.5 (v/v) % or less, 15.0 (v/v) % or less, 14.5 (v/v) % or less, 14.0 (v/v) % or less, 13.5 (v/v) % or less, 13.0 (v/v) % or less, 12.5 (v/v) % or less, 12.0 (v/v) % or less, 11.5 (v/v) % or less, 11.0 (v/v) % or less, 10.5 (v/v) % or less, 10.0 (v/v) % or less, 9.5 (v/v) % or less, 9.0 (v/v) % or less, 8.5 (v/v) % or less, or 8.0 (v/v) % or less from a point of view of improving the balance between the alcohol content and the original extract concentration and reducing an unsuitable grain odor.

In addition, the beer-taste beverage according to one aspect of the present invention may be a non-alcohol beer-taste beverage having an alcohol content of less than 1 (v/v) %, and the alcohol content of the beer-taste wort for producing the non-alcohol beer-taste beverage is preferably adjusted to be 1.0 (v/v) % or less, 0.9 (v/v) % or less, 0.8 (v/v) % or less, 0.7 (v/v) % or less, 0.6 (v/v) % or less, 0.5 (v/v) % or less, 0.4 (v/v) % or less, 0.3 (v/v) % or less, 0.2 (v/v) % or less, 0.1 (v/v) % or less, or less than 0.1 (v/v) %.

Note that, as used herein, the alcohol content is indicated as a percentage ((v/v) %) based on volume/volume. In addition, the alcohol content of the beverage can be measured by any known method, and for example, can be measured by a method using oscillation-type density meters described in “3 Sake 3-4 Alcohol Content” in the Official Methods of Analysis (Instruction) specified by the National Tax Agency.

In addition, the adjustment of the alcohol content can be performed by appropriately setting the addition of diluent water or carbonated water and the addition amount thereof if added, the type of raw material (barley or wheat, malt, corn grits, sugar solution etc.), the amount of the raw material, the type of enzyme, the addition amount of enzyme, the timing for the addition of enzyme, the amount of time for saccharification in mashing tank, the amount of time for proteolysis in mashing tank, the pH in mashing tank, the pH in mashing process (wort production step from malt addition until before yeast addition), the amount of an acid to be used during the pH adjustment, the timing for the pH adjustment (during mashing, during fermentation, at the time when fermentation is complete, before wort filtration, after wort filtration, or the like), the setting temperature and the retention time in each temperature region during wort preparation (including during saccharification), the original extract concentration of a pre-fermentation liquid, an original extract concentration in fermentation step, fermentation conditions (oxygen concentration, aeration conditions, the variety of yeast, addition amount of yeast, the number of proliferated yeast cells, the timing for yeast removal, fermentation temperature, the amount of time for fermentation, pressure setting, carbon dioxide concentration, addition amount of enzyme, type of enzyme, the timing for enzyme addition, or the like), the addition of spirits, brewed alcohol or the like, and others.

The beer-taste wort according to one aspect of the present invention may contain, or need not contain, as an alcohol component, spirits (distilled liquor) derived from cereal grains such that the alcohol content is adjusted to be within the range set forth above. The beer-taste wort according to one aspect of the present invention is preferably a wort containing no spirits from a point of view of making a wort for producing a beer-taste beverage that has a good taste and tastes like beer.

Note that, as used herein, spirits refers to an alcoholic beverage that is obtained through a process in which cereals such as barley or wheat, rice, buckwheat, maize, potato, and sugar cane are used as raw materials and saccharified with malt, or with an enzyme preparation as necessary, followed by fermentation with yeasts, and further distillation. The cereal grain as a raw material of spirits is preferably a plant belonging to the family Gramineae, and is more preferably barley or wheat.

The concentration of an original extract (O-Ex) of the beer-taste wort according to one aspect of the present invention is preferably 15.0 mass % or more, 15.5 mass % or more, more preferably 16.0 mass % or more, 16.5 mass % or more, still more preferably 17.0 mass % or more, 17.5 mass % or more, even more preferably 18.0 mass % or more, 18.5 mass % or more, particularly preferably 19.0 mass % or more, or 19.5 mass % or more from a point of view of making a wort for producing a beer-taste beverage that has a good taste and tastes like beer, and may be 20.0 mass % or more, 21.0 mass % or more, 22.0 mass % or more, 22.5 mass % or more, 23.0 mass % or more, 23.5 mass % or more, 24.0 mass % or more, 24.5 mass % or more, 25.0 mass % or more, 25.5 mass % or more, 26.0 mass % or more, 26.5 mass % or more, or 27.0 mass % or more.

In addition, the concentration of the original extract (O-Ex) of the beer-taste wort is preferably 50.0 mass % or less, 49.0 mass % or less, 48.0 mass % or less, more preferably 47.0 mass % or less, 46.0 mass % or less, 45.0 mass % or less, still more preferably 44.0 mass % or less, 43.0 mass % or less, 42.0 mass % or less, even more preferably 41.0 mass % or less, 40.0 mass % or less, and particularly preferably 39.0 mass % or less from a point of view of making a beer-taste wort with less unsuitable grain odor derived from malt, and may be 38.0 mass % or less, 37.0 mass % or less, 36.0 mass % or less, 35.0 mass % or less, 34.0 mass % or less, 33.0 mass % or less, 32.0 mass % or less, 31.0 mass % or less, or 30.0 mass % or less.

The adjustment of the original extract concentration can be performed by appropriately setting the addition of diluent water or carbonated water and the addition amount thereof if added, the type of raw material (barley or wheat, malt, corn grits, sugar solution etc.), the amount of the raw material, the amount of time of wort filtration, the pH during wort filtration, the amount of time of boiling, the boiling temperature, the addition amount of spirits, the addition amount of brewed alcohol, and the like.

The original extract of the beer-taste wort according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition, 2013).

The concentration of a real extract (an authentic extract) in the beer-taste wort according to one aspect of the present invention is preferably 3.0 mass % or more from a point of view of making a wort for obtaining a full-bodied beer-taste beverage. The real extract refers to a solid matter itself (a soluble evaporation residue) which is dissolved particularly in a fermentable beverage and remains as a dried residue that does not evaporate at the time when gently heating the beverage (after being filtered to remove insoluble matters such as yeasts and coagulated proteins if present) to allow all of water, alcohol, carbon dioxide and other volatile components to evaporate, or refers to a content of the solid matter (in mass %). From the point of view set forth above, the real extract concentration of the beer-taste wort according to one aspect of the present invention is preferably 3.0 mass % or more, more preferably 3.5 mass % or more, still more preferably 4.0 mass % or more, and particularly preferably 4.5 mass % or more, and may be 5.0 mass % or more, 5.5 mass % or more, 6.0 mass % or more, 6.5 mass % or more, 7.0 mass % or more, 7.5 mass % or more, 8.0 mass % or more, 8.5 mass % or more, 9.0 mass % or more, 9.5 mass % or more, or 10.0 mass % or more.

On the other hand, the real extract concentration of the beer-taste wort according to one aspect of the present invention is preferably 10.0 mass % or less, more preferably 9.5 mass % or less, still more preferably 9.0 mass % or less, even more preferably 8.5 mass % or less, and particularly preferably 8.0 mass % or less from a point of view of making a wort for obtaining a light-bodied beer-taste beverage, and may be 7.5 mass % or less, 7.0 mass % or less, 6.5 mass % or less, 6.0 mass % or less, 5.5 mass % or less, or 5.0 mass % or less.

The adjustment of the real extract concentration can be performed by appropriately setting the addition of diluent water or carbonated water and the addition amount thereof if added, the type of raw material (barley or wheat, malt, corn grits, corn protein, collagen peptide, sugar solution etc.), the amount of the raw material, the amount of time for wort filtration, the pH in wort filtration, the amount of time for boiling, boiling temperature, the addition amount of spirits, the addition amount of brewed alcohol, and others.

The real extract concentration of the beer-taste wort according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition, 2013).

The total nitrogen amount of the beer-taste wort according to one aspect of the present invention is preferably 45 mg/100 mL or more, more preferably 50 mg/100 mL, still more preferably 55 mg/100 mL or more, even more preferably 60 mg/100 mL or more, and particularly preferably 65 mg/100 mL or more from a point of view of further improving a full-bodied taste of the beer-taste beverage obtained by diluting the wort, and may be 70 mg/100 mL or more, 75 mg/100 mL or more, 80 mg/100 mL or more, 85 mg/100 mL or more, 90 mg/100 mL or more, 95 mg/100 mL or more, 100 mg/100 mL or more, 105 mg/100 mL or more, 110 mg/100 mL or more, 115 mg/100 mL or more, 120 mg/100 mL or more, 125 mg/100 mL or more, or 130 mg/100 mL or more. When the total nitrogen amount of the beer-taste wort is within the range set forth above, a beer-taste beverage excellent in a full-bodied taste can be produced even when the beer-taste wort is diluted by a factor of 2 to 10, for example.

On the other hand, from a point of view of making a wort for producing a beer-taste beverage that is less likely to give a feeling of fullness, the total nitrogen amount of the beer-taste wort according to one aspect of the present invention is preferably 300 mg/100 mL or less, 290 mg/100 mL or less, 280 mg/100 mL or less, 270 mg/100 mL or less, 260 mg/100 mL or less, or 250 mg/100 mL or less.

The term “total nitrogen amount” in the present invention refers to the total amount of all nitrogen compounds such as proteins and amino acids. The total nitrogen amount can be controlled by adjusting the usage amounts of raw materials that contain proteins and amino acids. Specifically, the total nitrogen amount can be increased by increasing the amount of a raw material having a high nitrogen content, such as malt. Examples of the raw material having a high nitrogen content include malt, soybean, yeast extract, peas, and ungerminated cereal grains. Examples of the ungerminated cereal grain include ungerminated barley, wheat, rye, wild oats, oats, adlay, common oats, soybeans, and peas. Apart from these, examples thereof include maize (corn protein etc.), rice, dairy ingredients such as raw milk, skim milk powder, and whey, collagen peptide, and yeast extract. The total nitrogen amount can be adjusted by appropriately setting the addition of diluent water or carbonated water and the addition amount thereof if added, the type and amount of spirits, the type and amount of brewed alcohol, and the selection of the use amount and type of raw material, as well as the type of enzyme, the addition amount of enzyme (including proteolytic enzyme etc.), the timing for enzyme addition, the amount of time for proteolysis in mashing tank, the pH in the mashing tank, the pH in mashing process (wort production step from malt addition until before yeast addition), the amount of time for wort filtration, the setting temperature and the retention time in each temperature region in the preparation of wort, the amount of time for boiling and the pH in boiling step, the original extract concentration in a pre-fermentation liquid, the original extract concentration in fermentation step, the fermentation conditions (oxygen concentration, aeration conditions, the variety of yeast, the amount of yeasts added, the number of proliferated yeast cells, the timing for yeast removal, fermentation temperature, the amount of time for fermentation, pressure setting, carbon dioxide concentration, etc.), the timing for cooling, the cooling temperature, the amount of time for cooling, wort filtration conditions (such as flow rate, temperature), the wort filtration type (such as diatomaceous earth, membrane, sheet, cartridge, filter), and a stabilizer (such as silica gel, polyvinylpolypyrrolidone (PVPP), bentonite, tannin, bentonite, white clay, acid clay) to be added during wort filtration etc.

The total nitrogen amount of the beer-taste wort according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition, 2013).

The total polyphenol amount in the beer-taste wort according to one aspect of the present invention is preferably 500 ppm by mass or less, more preferably 490 ppm by mass or less, further more preferably 480 ppm by mass or less, even more preferably 470 ppm by mass or less, even more preferably 460 ppm by mass or less, even more preferably 450 ppm by mass or less, and particularly preferably 440 ppm by mass or less from a point of view of further improving the refreshing taste of the beer-taste beverage obtained by diluting the wort, and may be 430 ppm by mass or less, 420 ppm by mass or less, 410 ppm by mass or less, 400 ppm by mass or less, 380 ppm by mass or less, 360 ppm by mass or less, 340 ppm by mass or less, 320 ppm by mass or less, 300 ppm by mass or less, 280 ppm by mass or less, 260 ppm by mass or less, 240 ppm by mass or less, 220 ppm by mass or less, 200 ppm by mass or less, 180 ppm by mass or less, 160 ppm by mass or less, or 140 ppm by mass or less. When the total polyphenol amount is within the range set forth above, a beer-taste beverage having a good refreshing taste can be produced even when the beer-taste wort is diluted by a factor of 2 to 10, for example.

On the other hand, from a point of view of making a wort for producing a beer-taste beverage having a further improved taste, the total polyphenol amount in the beer-taste wort according to one aspect of the present invention is preferably 10 ppm by mass or more, 20 ppm by mass or more, 30 ppm by mass or more, 40 ppm by mass or more, 50 ppm by mass or more, 60 ppm by mass or more, 70 ppm by mass or more, 80 ppm by mass or more, 90 ppm by mass or more, 100 ppm by mass or more, more than 100 ppm by mass, 110 ppm by mass or more, 120 ppm by mass or more, 130 ppm by mass or more, 140 ppm by mass or more, or 150 ppm by mass or more.

The polyphenol refers to a compound in which two or more hydrogen atoms of an aromatic hydrocarbon are substituted with hydroxyl groups. Examples of the polyphenol include flavonols, isoflavone, tannin, catechin, quercetin, and anthocyanin.

The term “total polyphenol amount” as used herein is the total amount of these polyphenols contained in the beer-taste wort.

The total polyphenol amount of the beer-taste wort according to one aspect of the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition, 2013).

The content of free amino nitrogen in the beer-taste wort according to one aspect of the present invention is preferably 40 mg/100 mL or less, more preferably 38 mg/100 mL or less, still more preferably 36 mg/100 mL or less, even more preferably 34 mg/100 mL or less, and particularly preferably 32 mg/100 mL or less from a point of view of further improving the crisp taste of the beer-taste beverage obtained by diluting the wort, and may be 30 mg/100 mL or less, 28 mg/100 mL or less, 26 mg/100 mL or less, 24 mg/100 mL or less, 22 mg/100 mL or less, 20 mg/100 mL or less, 18 mg/100 mL or less, 16 mg/100 mL or less, 14 mg/100 mL or less, 12 mg/100 mL or less, or 10 mg/100 mL or less. When the content of free amino nitrogen is within the range set forth above, a beer-taste beverage excellent in crisp taste can be produced even when the beer-taste wort is diluted by a factor of 2 to 10, for example.

On the other hand, from a point of view of making a wort for producing a beer-taste beverage having a further improved taste, the content of free amino nitrogen may be 1 mg/100 mL or more, 2 mg/100 mL or more, 3 mg/100 mL or more, 4 mg/100 mL or more, 5 mg/100 mL or more, 6 mg/100 mL or more, 7 mg/100 mL or more, 8 mg/100 mL or more, 9 mg/100 mL or more, or 10 mg/100 mL or more.

The content of free amino nitrogen (FAN) refers to the total amount of free a-amino nitrogen, and is used as a numerical index of amino acids contained in raw materials such as barley or wheat, malt, yeast extract, collagen, and soybean. The content of the free amino nitrogen can be measured, for example, by a method described in “8.18 Free Amino Nitrogen” of Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition, 2013).

The adjustment of the total polyphenol amount and the free amino nitrogen content can be made by appropriately setting the addition of diluent water or carbonated water and the addition amount thereof if added, the type of raw material (such as barley or wheat, malt, corn grits, sugar solution, etc.), the amount of raw material, the type of enzyme, the addition amount of enzyme, the timing for enzyme additions, the polyphenol polymerization conditions (such as temperature, agitating speed, etc.) in mashing tank, the pH in the mashing tank, the pH in mashing process (wort production step from malt addition until before yeast addition), the amount of time for wort filtration, the setting temperature and the retention time in each temperature region during preparation of wort (including during saccharification), the original extract concentration of the pre-fermentation liquid, the original extract concentration in the fermentation step, the fermentation conditions (such as oxygen concentration, aeration conditions, the variety of yeast, the amount of yeast added, the number of proliferated yeast cells, the timing for yeast removal, fermentation temperature, the amount of time for fermentation, pressure setting, carbon dioxide concentration, etc.), the timing for cooling, the cooling temperature, the amount of time for cooling, wort filtration type (such as diatomaceous earth, membrane, sheet, cartridge, filter, etc.), activated carbon, a stabilizer (such as silica gel, polyvinylpolypyrrolidone (PVPP), bentonite, tannin, bentonite, etc.) to be added during wort filtration, and the like.

Moreover, the total polyphenol amount and the free amino nitrogen content of the beer-taste wort of the present invention can be controlled, for example, by adjusting the amount of the raw material with high polyphenol or amino acid content, such as malt and the husks (hulls) of malt. Specifically, the total polyphenol amount and the free amino nitrogen content can be reduced by reducing the amount of the raw material such as malt with high polyphenol or amino acid content.

In the beer-taste wort according to one aspect of the present invention, the content of phosphoric acid is preferably 350 mg/L or more, more preferably 370 mg/L or more, further more preferably 390 mg/L or more, still more preferably 400 mg/L or more, still more preferably 420 mg/L or more, and particularly preferably 440 mg/L or more from a point of view of further improving the stimulating taste of the beer-taste beverage obtained by diluting the wort, and may be 460 mg/L or more, 480 mg/L or more, 500 mg/L or more, 520 mg/L or more, 540 mg/L or more, 560 mg/L or more, 580 mg/L or more, 600 mg/L or more, 620 mg/L or more, 640 mg/L or more, 660 mg/L or more, 680 mg/L or more, 700 mg/L or more, 720 mg/L or more, 740 mg/L or more, 760 mg/L or more, 780 mg/L or more, 800 mg/L or more, 820 mg/L or more, 840 mg/L or more, 860 mg/L or more, 880 mg/L or more, 900 mg/L or more, 920 mg/L or more, 940 mg/L or more, 960 mg/L or more, 980 mg/L or more, 1000 mg/L or more, 1050 mg/L or more, 1100 mg/L or more, 1150 mg/L or more, 1200 mg/L or more, 1250 mg/L or more, 1300 mg/L or more, 1350 mg/L or more, or 1400 mg/L or more. When the phosphoric acid content is within the range set forth above, a beer-taste beverage with good stimulating taste can be produced even when the beer-taste wort is diluted by a factor of 2 to 10, for example.

On the other hand, from a point of view of making a wort for producing a beer-taste beverage that is not too sour, the phosphoric acid content is preferably 2000 mg/L or less, 1900 mg/L or less, 1800 mg/L or less, 1700 mg/L or less, 1600 mg/L or less, 1500 mg/L or less, or 1450 mg/L or less.

The phosphoric acid content can be measured by a high-performance liquid chromatography (HPLC) method.

In the beer-taste wort according to one aspect of the present invention, the content of proline is preferably 500 μmol/L or more, more preferably 1000 μmol/L or more, more preferably 1500 μmol/L or more, further preferably 2000 μmol/L or more, further preferably 2500 μmol/L or more, still more preferably 3000 μmol/L or more, still more preferably 3500 μmol/L or more, and particularly preferably 4000 μmol/L or more from a point of view of making a wort for obtaining a beer-taste beverage with a deep taste, and the proline content may be 4500 μmol/L or more, 5000 μmol/L or more, 5500 μmol/L or more, 6000 μmol/L or more, 6500 μmol/L or more, 7000 μmol/L or more, 7500 μmol/L or more, or 8000 μmol/L or more.

In addition, the proline content may be 10000 μmol/L or less, 9500 μmol/L or less, 9000 μmol/L or less, 8500 μmol/L or less, 8000 μmol/L or less, 7500 μmol/L or less, 7000 μmol/L or less, 6500 μmol/L or less, or 6000 μmol/L or less from the point of view of making a wort for obtaining a beer-taste beverage with a smooth and light taste.

Herein, the proline content can be measured with, for example, an amino acid automatic analyzer L-8800A manufactured by Hitachi, Ltd.

The proline may be an ingredient contained in the raw material of the beer-taste wort, or may be an ingredient that is separately added in the production process (e.g., a purified proline product).

The adjustment of the proline content can be made by appropriately setting the addition amount of diluent water or carbonated water and the addition amount thereof in the case of dilution, the type of the amino acid-containing raw material (such as barley or wheat, malt, corn grits, yeast extract, soybean, pea, corn protein, collagen peptide, purified proline product, etc.), the amount of the raw material, the type of enzyme (such as proteolytic enzyme etc.), the addition amount of the enzyme, the timing for enzyme addition, the amount of time for saccharification in mashing tank, the amount of time for protein decomposition in the mashing tank, the pH in the mashing tank, the pH in mashing process (wort production step from malt addition until before yeast addition), the addition amount of an acid used in the pH adjustment, the timing for pH adjustment (during mashing, during fermentation, at the time when fermentation is complete, prior to wort filtration, after wort filtration, etc.), the setting temperature and the retention time of each temperature region in the preparation of wort (including during saccharification), the original extract concentration of the pre-fermentation liquid, the original extract concentration in the fermentation step, the fermentation conditions (such as oxygen concentration, aeration conditions, the variety of yeast, the addition amount of yeast, the number of proliferated yeast cells, the timing for yeast removal, fermentation temperature, the amount of time for fermentation, pressure setting, carbon dioxide concentration, etc.), the addition of spirits or alcohol, and the like.

The content of pyroglutamic acid in the beer-taste wort according to one aspect of the present invention is preferably 50 mg/L or more, more preferably 100 mg/L or more, further more preferably 150 mg/L or more, even more preferably 200 mg/L or more, and particularly preferably 250 mg/L or more from a point of view of making a wort for obtaining a beer-taste beverage with a deep taste, and may be 300 mg/L or more, 350 mg/L or more, 400 mg/L or more, 450 mg/L or more, 500 mg/L or more, 550 mg/L or more, 600 mg/L or more, 650 mg/L or more, 700 mg/L or more, 750 mg/L or more, or 800 mg/L or more.

On the other hand, the pyroglutamic acid content may be 1000 mg/L or less, 950 mg/L or less, 900 mg/L or less, 850 mg/L or less, 800 mg/L or less, 750 mg/L or less, 700 mg/L or less, 650 mg/L or less, 600 mg/L or less, 550 mg/L or less, 500 mg/L or less, 450 mg/L or less, or 400 mg/L or less from a point of view of making a wort for obtaining a beer-taste beverage with a light and smooth taste.

Pyroglutamic acid may be an ingredient contained in the raw material of the beer-taste wort, or may be an ingredient that is separately added in the production process (e.g., a purified pyroglutamic acid product).

The adjustment of the pyroglutamic acid content can be made by appropriately setting the addition of diluent water or carbonated water and the addition amount thereof if added, the addition of a purified pyroglutamic acid product, the type of the pyroglutamic acid-containing raw material (such as barley or wheat, malt, corn grits, sugar solution, yeast extract, soybean, pea, or a purified pyroglutamic acid product), the amount of the raw materials, the amount of time for enzyme reaction in mashing process (wort production step from the addition of raw materials such as malt until before yeast addition), the pH in the mashing process, the addition amount of an acid used in the pH adjustment, the timing for pH adjustment (during mashing, during fermentation, at the time when fermentation is complete, prior to wort filtration, after wort filtration, etc.), the setting temperature and retention time in each temperature region during wort preparation (including during saccharification), the original extract concentration of a pre-fermentation liquid, the original extract concentration in a fermentation step, the fermentation conditions (such as the oxygen concentration, aeration conditions, the variety of yeast, the amount of yeast added, the number of proliferated yeast cells, the timing for yeast removal, fermentation temperature, the amount of time for fermentation, pressure setting, and carbon dioxide concentration, etc.), and the addition of spirits or brewed alcohol, or the like. Note that, herein, the pyroglutamic acid content can be measured by, for example, high-performance liquid chromatography.

In the beer-taste wort according to one aspect of the present invention, the content of linalool is 1000 ug/L or less from a point of view of imparting a fragrant aroma, but may be 950 ug/L or less, 900 ug/L or less, 850 ug/L or less, 800 ug/L or less, 750 ug/L or less, 700 ug/L or less, 650 ug/L or less, 600 ug/L or less, 550 ug/L or less, 500 ug/L or less, 450 ug/L or less, 400 ug/L or less, 350 ug/L or less, 300 ug/L or less, 250 ug/L or less, 200 ug/L or less, 175 ug/L or less, 150 ug/L or less, 125 ug/L or less, 100 ug/L or less, 90 ug/L or less, or 80 ug/L or less.

In addition, in the beer-taste wort according to one aspect of the present invention, the content of linalool is 1 ug/L or more from a point of view of providing depth of flavor, but may be 5 ug/L or more, 10 ug/L or more, 15 ug/L or more, 20 ug/L or more, 25 ug/L or more, 30 ug/L or more, 35 ug/L or more, 40 ug/L or more, 45 ug/L or more, 50 ug/L or more, 55 ug/L or more, 60 ug/L or more, 65 ug/L or more, 70 ug/L or more, 75 ug/L or more, 80 ug/L or more, 85 ug/L or more, 90 ug/L or more, 95 ug/L or more, or 100 ug/L or more.

Note that, the content of linalool can be measured using, for example, a gas chromatograph-mass spectrometer (GC-MS) described in J. Agric. Food Chem., 2013, 61 (47), pp 11303-1131 (Characterization of the Key Aroma Compounds in Two Bavarian Wheat Beers by Means of the Sensomics Approach).

Furthermore, in the beer-taste wort according to one aspect of the present invention, the content of linalool can be controlled by, for example, adjusting the amount of linalool added, or adjusting the variety of a raw material (such as hops, etc.) having a high linalool content, the use amount thereof, the timing for addition of this raw material, or the like.

From a point of view of enhancing the flavor, the pH of the beer-taste wort according to one aspect of the present invention is preferably 2.0 or more, 2.2 or more, 2.4 or more, 2.6 or more, 2.8 or more, 3.0 or more, 3.1 or more, 3.2 or more, 3.3 or more, 3.4 or more, 3.5 or more, 3.6 or more, 3.7 or more, 3.8 or more, 3.9 or more, or 4.0 or more, and is preferably 5.4 or less, 5.2 or less, 5.0 or less, 4.9 or less, 4.8 or less, 4.7 or less, 4.6 or less, 4.55 or less, or 4.5 or less, and can also be 4.0 or less, or less than 4.0.

The adjustment of the pH can be made by appropriately setting the addition of diluent water or carbonated water and the addition amount thereof if added, the type of raw material (such as barley or wheat, malt, corn grits, sugar solution, etc.), the amount of the raw material, the type of enzyme, the amount of enzyme added, the timing for enzyme addition, the amount of time for saccharification in a mashing tank, the amount of time for proteolysis in the mashing tank, the pH in the mashing tank, the pH in mashing process (wort production step from malt addition until before yeast addition), the type of an acid (such as lactic acid, phosphoric acid, malic acid, tartaric acid, or citric acid) used during the pH adjustment, the addition amount of the acid used in the pH adjustment, the timing for pH adjustment (during mashing, during fermentation, at the time when fermentation is complete, prior to wort filtration, after wort filtration, etc.), the setting temperature and retention time in each temperature region during wort preparation (including during saccharification), the original extract concentration in the pre-fermentation liquid, the original extract concentration in the fermentation step, the fermentation conditions (such as the oxygen concentration, aeration conditions, yeast species, amount of yeast added, the number of proliferated yeast cells, the timing for yeast removal, fermentation temperature, the amount of time for fermentation, pressure setting, and carbon dioxide concentration), the timing for cooling, the cooling temperature, the amount of time for cooling, and others.

The beer-taste wort according to one aspect of the present invention may be a beer-taste wort underwent heat treatment so that the invertase activity value thereof is adjusted to be within a predetermined range, or may be a beer-taste wort without heat treatment.

The invertase activity value of the beer-taste wort underwent the heat treatment may be 55 units or less, 50 units or less, 45 units or less, 40 units or less, 35 units or less, 30 units or less, 25 units, 20 units or less, 15 units or less, or 10 units or less. Note that the lower limit value of the invertase activity value of the beer-taste wort underwent the heat treatment is 0 unit or more.

The invertase activity value of the beer-taste wort without heat treatment may be more than 55 units, 60 units or more, 65 units or more, 70 units or more, 75 units or more, 80 units or more, 85 units or more, 90 units or more, or 95 units or more. Note that the upper limit of the invertase activity value of the beer-taste wort underwent the heat treatment is 100 units or less.

The aforesaid term “invertase activity value” is an index indicating the degree of heat load on the beer-taste wort. The invertase is derived from yeast, and when heat treatment is not performed in a step after yeast addition, the invertase is not deactivated. On the other hand, when the heat treatment is performed, the invertase is deactivated and the invertase activity value also decreases depending on various conditions of the heat treatment. Note that the invertase activity value can be adjusted by appropriately setting various conditions (such as heating temperature, the amount of time for heating, the timing for heating) of the aforesaid heat treatment.

Herein, the invertase activity value can be measured by the following method.

### (1) Preparation of Various Reagents

### (Acetate Buffer)

A solution was prepared by dissolving 4.536 g of sodium acetate trihydrate (CH₃COONa·3H₂O) in about 350 mL of distilled water, and with the pH of this solution being measured with a pH-meter, about 1.9 mL of acetic acid (CH₃COOH) was added to this solution and the pH was adjusted to 4.5. Thereafter, distilled water was added thereto to adjust the volume to 500 mL and thereby preparing an acetate buffer. (Substrate solution)

In 125 mL of the thus obtained acetate buffer was dissolved 30.0 g of sucrose and distilled water was added thereto to adjust the volume of the solution to 500 mL and thereby preparing a substrate solution.

### (DNSA Solution)

In distilled water were dissolved 127.5 g of Rochelle salt (potassium sodium tartrate), 4.4 g of 3,5-dinitrosalicylic acid (DNSA), 3.5 g of phenol, and 3.5 of sodium metabisulfite and the volume of this solution was adjusted to 1 L to prepare a DNSA solution.

### (2) Measurement Method

In advance, a beer-taste wort to be measured was heat treated at 100° C. for 10 minutes and thereby preparing a control sample.

Thereafter, 1.25 mL of a test sample of a beer-taste wort to be measured was added to 5 mL of the substrate solution, and the mixture was allowed to react at 30° C. for exactly 1 hour. After 1 hour, 0.5 mL of this reaction solution was added into 5 mL of distilled water, which had been placed in another test tube in advance, and thereby diluted to prepare a diluted solution, and 0.5 mL of this diluted solution was immediately added to 5 mL of the DNSA solution placed in another tester and they were mixed well. Furthermore, this DNSA solution was heated in a hot water bath at 100° C. for 3 minutes to cause a color reaction, and after the heating, it was quickly cooled to room temperature.

Also, the control sample that had been heat treated as described above was also allowed to go through the operations similar to the test sample until the color reaction, and then cooled to room temperature.

Thereafter, the heat-treated control sample was used as a blank, the test beverage was measured for its absorbance at 540 nm, and the mass X (in mg) of the produced reducing sugar was determined from the absorbance value by using a calibration curve created by glucose of known concentrations. Based on that, the invertase activity value was calculated from the following equation.

$$Invertase activity value ( Unit ) = X \times D \times 2$$

(In the equation set forth above, X is the mass (in mg) of the reducing sugar determined from the absorbance, and D is the dilution ratio (e.g., D=55).)

When the beer-taste wort according to one aspect of the present invention is a fermentation wort, the apparent attenuation is preferably 70% or more, more preferably 75% or more, still more preferably 80% or more, even more preferably 85% or more, and particularly preferably 90% or more from a point of view of making a wort for obtaining a beer-taste beverage with a light and smooth taste, and may be 95% or more, 100% or more, 105% or more, 110% or more, or 115% or more.

In addition, from a point of view of making a wort for obtaining a beer-taste beverage with a deep taste, the apparent attenuation may be 115% or less, 105% or less, 100% or less, 95% or less, 90% or less, 85% or less, or 80% or less.

As used herein, the term “apparent attenuation” refers to the percentage of sugar concentration that yeasts can consume as a nutrient source for alcohol fermentation out of the total sugar concentration contained in a pre-fermentation liquid. For example, the apparent attenuation AA of the beer-taste wort of the present invention can be calculated from Equation (1) set forth below.

$$AA ( \% ) = 100 \times ( P - Es ) / P \qquad Equation ( 1 )$$

In Equation (1) set forth above, “P” is an original extract (original wort extract), and can be measured by the method described in the “BCOJ Beer Analysis Method” (published by The Brewing Society of Japan, edited by Brewery Convention of Japan, Revised on Nov. 1, 2004).

In addition, “Es” represents an apparent extract of the beer-taste wort. The apparent extract can be calculated, for example, from Equation (2) set forth below as described in the “BCOJ Beer Analysis Method” (published by The Brewing Society of Japan, edited by Brewery Convention of Japan, Revised on Nov. 1, 2004).

$$Es = - 46 \; 0.234 + 662.649 \times D - 202.414 \times {D}^{2} \qquad Equation ( 2 )$$

(In Equation (2), D is the specific gravity of the degassed beer-taste beverage.) Note that, the apparent extract “Es” may have a negative value depending on D in Equation (2) set forth above, and thus the calculated apparent attenuation may be more than 100% in some cases.

Incidentally, the adjustment of the apparent attenuation of the beer-taste wort can be made by appropriately setting the addition amount of diluent water or carbonated water and the addition amount thereof if added, the type of raw material (such as barley or wheat, malt, corn grits, sugar solution, etc.), the amount of the raw material, the type of enzyme, the addition amount of enzyme (including glycolytic enzymes, isomerase, etc.), the temperature during enzyme reaction, the timing for enzyme addition, the amount of time for saccharification, the pH during saccharification, the temperature during saccharification, the pH in mashing process (wort production step from malt addition until before yeast addition), the temperature in mashing process, the amount of time for wort filtration, the setting temperature and the retention time in each temperature region during the preparation of wort (including during saccharification), the original extract concentration of the pre-fermentation liquid, the original extract concentration in the fermentation step, the fermentation conditions (such as oxygen concentration, aeration conditions, the variety of yeast, the addition amount of yeasts, the number of proliferated yeast cells, the timing for yeast removal, fermentation temperature, the amount of time for fermentation, pressure setting, carbon dioxide concentration, the addition amount of enzyme, type of enzyme, the timing for enzyme addition, etc.), the timing for cooling, the cooling temperature, the amount of time for cooling, and others.

The chromaticity of the beer-taste wort according to one aspect of the present invention is preferably 20 EBC or higher, more preferably 25 EBC or higher, still more preferably 30 EBC or higher, and particularly preferably 35 EBC or higher from a point of view of making a wort for obtaining a beer-taste beverage with a deep taste, and may be 40 EBC or higher, 45 EBC or higher, 50 EBC or higher, 55 EBC or higher, 60 EBC or higher, 65 EBC or higher, 70 EBC or higher, 75 EBC or higher, 80 EBC or higher, 85 EBC or higher, 90 EBC or higher, 95 EBC or higher, or 100 EBC or higher.

In addition, the chromaticity of the beer-taste wort according to one aspect of the present invention may be 100 EBC or lower, 95 EBC or lower, 90 EBC or lower, 85 EBC or lower, 80 EBC or lower, 75 EBC or lower, 70 EBC or lower, 65 EBC or lower, 60 EBC or lower, 55 EBC or lower, 50 EBC or lower, 45 EBC or lower, or 40 EBC or lower from a point of view of making a wort for obtaining a beer-taste beverage with a light and smooth taste.

As used herein, the “chromaticity” can be measured by a measurement method described in “8.8 Chromaticity” of Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013). Note that the “chromaticity” is specified by a unit of chromaticity (EBC unit) defined by the European Brewing Convention. The lower the chromaticity value, the lighter and brighter color the beverage has, whereas the higher the value, the deeper and darker color the beverage has.

Incidentally, the chromaticity of the beer-taste wort according to one aspect of the present invention can be controlled by adjusting the type of barley or wheat and malt to be used, for example, and when two or more types of barley or wheat and malt are used in combination, the chromaticity can be controlled by adjusting the blending ratio thereof, or the like. Moreover, the chromaticity can also be adjusted by controlling the amount of a food additive such as caramel pigment, cacao pigment, or safflower pigment, the amount of a colored sugar solution, or the like.

The bitterness units of the beer-taste wort according to one aspect of the present invention is preferably 20 BUs or higher, more preferably 25 BUs or higher, still more preferably 30 BUs or higher, particularly preferably 35 BUs or higher from a point of view of making a wort for obtaining a full-bodied beer-taste beverage, and may be 40 BUs or higher, 45 BUs or higher, 50 BUs or higher, 55 BUs or higher, 60 BUs or higher, 65 BUs or higher, 70 BUs or higher, 75 BUs or higher, 80 BUs or higher, 85 BUs or higher, 90 BUs or higher, 95 BUs or higher, or 100 BUs or higher.

The bitterness units of the beer-taste wort according to one aspect of the present invention may be 100 BUs or lower, 95 BUs or lower, 90 BUs or lower, 85 BUs or lower, 80 BUs or lower, 75 BUs or lower, 70 BUs or lower, 65 BUs or lower, 60 BUs or lower, 55 BUs or lower, 50 BUs or lower, 45 BUs or lower, or 40 BUs or lower from a point of view of making a wort for obtaining a beer-taste beverage with a light and smooth taste.

As used herein, the term “bitterness units” refers to an indicator of bitterness caused by iso-a-acids such as isohumulone. The bitterness units can be measured in accordance with the method described in paragraph “8.15 Bitterness units” of “BCOJ Beer Analysis Method” (Revised edition on Nov. 1, 2004). Specifically, the bitterness units (BUs) can be determined through a process in which an acid is added to a degassed sample, followed by extraction with isooctane, and the absorbance of the resulting isooctane layer is measured at a 275 nm with using isooctane as a control, and the measured absorbance is multiplied by a factor. The bitterness units depend on the iso-a-acid content, and the iso-a-acid is a bitterness component highly contained in hops. Therefore, a beer-taste wort with a predetermined bitterness units can be produced by controlling the amounts of hops used.

The total turbidity (T-Haze) of the beer-taste wort according to one aspect of the present invention may be 10 Helm or more, 25 Helm or more, 50 Helm or more, 75 Helm or more, 100 Helm or more, 125 Helm or more, 150 Helm or more, 175 Helm or more, 200 Helm or more, 225 Helm or more, 250 Helm or more, 275 Helm or more, or 300 Helm or more from a point of view of making a wort for obtaining a beer-taste beverage with a deep taste.

In addition, from a point of view of making a wort for obtaining a beer-taste beverage with a light and smooth taste, the total turbidity may be 500 Helm or less, 475 Helm or less, 450 Helm or less, 425 Helm or less, 400 Helm or less, 375 Helm or less, 350 Helm or less, 325 Helm or less, or 300 Helm or less.

As used herein, “turbidity” can be measured by the method described in Analytica EBC, Method 9.29, Haze in beer. Specifically, the turbidity can be measured through a process in which a sample to be measured is placed in a water bath at a constant temperature of 0° C. and held for 48 hours, the sample is lightly stirred to be homogenized, the sample is again placed in the water bath at a constant temperature of 0° C. until air bubbles disappear and held for several minutes, and then the value of scattered light at an angle of 90° for the total turbidity is read as “turbidity”.

The beer-taste wort of one aspect of the present invention is a wort intended to be diluted by a factor of 2 to 10, but the beer-taste wort may be diluted by a factor of 3 or more, by a factor of 4 or more, by a factor of 5 or more, by a factor of 6 or more, by a factor of 7 or more, by a factor of 8 or more, by a factor of 9 or more, or by a factor of 10 or more, and may be diluted by a factor of 9 or less, by a factor of 8 or less, by a factor of 7 or less, by a factor of 6 or less, by a factor of 5 or less, by a factor of 4 or less, by a factor of 3 or less, or by a factor of 2 or less.

The beer-taste wort according to one aspect of the present invention is suitable for an aspect of container package. Examples of containers include bottles, plastic bottles, cans (including bottle cans) or barrels. Examples of the container of a preferred aspect include a re-stoppable container. Specific examples thereof include re-stoppable bottles, re-stoppable plastic bottles, re-stoppable cans (e.g., re-stoppable bottle cans), and re-stoppable barrels.

1.1 Ingredients

As a main ingredient of the beer-taste wort according to one aspect of the present invention, malt may be used together with water, or malt need not be used. Furthermore, the beer-taste wort according to one aspect of the present invention may be a wort in which hops are used as an ingredient, or may be a wort without hops. Apart from these, a sweetener, a water-soluble dietary fiber, a bittering agent or a bitterness imparting agent, an antioxidant, a fragrance, an acidulant, a salt and the like may be used.

Malt refers to the seeds of barley, wheat, rye, wild oats, oats, adlay, common oats or the like that have undergone the process of germination, drying, and removal of rootlets, and there is no limitation on the production area and the variety.

In one aspect of the present invention, barley malt is preferably used. Barley malt is one of the most commonly used malt as a raw material for Japanese beer-taste beverages. Examples of barley include two-rowed barley and six-rowed barley, and any of them may be used. Furthermore, besides normal malts, colored malts and the like can also be used. Note that, when colored malts are used, different types of colored malts may be appropriately combined and used, or one type of colored malt may be used.

The malt used in one aspect of the present invention preferably has a modification of 80% or more. If the modification is less than 80%, the wort has an increased viscosity or an increased turbidity, and the production efficiency such as lautering efficiency and wort filterability deteriorates. Therefore, it is preferable to use malt having a modification of 80% or more. In Examples and Comparative Examples described later, malt having a modification of 80% or more was used. The modification can be measured by the method described in 3.1.3.8 Modification and Homogeneity (Calcofluor Carlsberg Method-EBC) in MEBAK Raw Materials Barley Adjuncts Malt Hops And Hop Products Published by the Chairman Dr. Fritz Jacob Self-published by MEBAK 85350 Freising-Weihenstephan, Germany 2011.

Note that, in the beer-taste wort according to one aspect of the present invention, it is preferable to appropriately select the malt to be used based on desired chromaticity, and a single type of the selected malt may be used alone, or two or more types may be used in combination.

The malt ratio (the usage ratio of all malt) of the beer-taste wort according to one aspect of the present invention is preferably 30 mass % or more, 35 mass % or more, 40 mass % or more, 45 mass % or more, 50 mass % or more, 55 mass % or more, 60 mass % or more, 65 mass % or more, 66 mass % or more, more than 66 mass %, 66.6 mass % or more, 67 mass % or more, 68 mass % or more, 69 mass % or more, 70 mass % or more, 71 mass % or more, 72 mass % or more, 73 mass % or more, 74 mass % or more, 75 mass % or more, 76 mass % or more, 77 mass % or more, 78 mass % or more, 79 mass % or more, 80 mass % or more, 81 mass % or more, 82 mass % or more, 83 mass % or more, 84 mass % or more, 85 mass % or more, 86 mass % or more, 87 mass % or more, 88 mass % or more, 89 mass % or more, 90 mass % or more, 91 mass % or more, 92 mass % or more, 93 mass % or more, 94 mass % or more, 95 mass % or more, 96 mass % or more, 97 mass % or more, 98 mass % or more, 99 mass % or more, or 100 mass %. An increased malt ratio can produce a beer-taste wort for producing a beer-taste beverage with a rich taste derived from malt and with a stronger flavor of barley or wheat.

On the other hand, the malt ratio of the beer-taste wort of one aspect according to the present invention may be less than 100 mass %, 99 mass % or less, 98 mass % or less, 97 mass % or less, 96 mass % or less, 95 mass % or less, 94 mass % or less, 93 mass % or less, 92 mass % or less, 91 mass % or less, 90 mass % or less, 89 mass % or less, 88 mass % or less, 87 mass % or less, 86 mass % or less, 85 mass % or less, 84 mass % or less, 83 mass % or less, 82 mass % or less, 81 mass % or less, 80 mass % or less, 79 mass % or less, 78 mass % or less, 77 mass % or less, 76 mass % or less, 75 mass % or less, 74 mass % or less, 73 mass % or less, 72 mass % or less, 71 mass % or less, 70 mass % or less, 69 mass % or less, 68 mass % or less, 67 mass % or less, less than 67 mass %, 66.6 mass % or less, 66 mass % or less, 65 mass % or less, 64 mass % or less, 63 mass % or less, 62 mass % or less, 61 mass % or less, 60 mass % or less, 59 mass % or less, 50 mass % or less, or less than 50 mass % from a point of view of making a wort for producing a beer-taste beverage less likely to give an unsuitable feeling of fullness.

As used herein, the term “malt ratio” refers to a value calculated according to the Interpretation Notice on the Liquor Tax Act and the Administrative Ordinance Related to Alcoholic Beverages and the like enforced on Apr. 1, 2018.

When suppressing the malt ratio, it is preferable to increase the amount of yeast assimilable raw materials (carbon source and nitrogen source) other than malt. Examples of carbon sources as the yeast assimilable raw material include monosaccharides, disaccharides, trisaccharides, and sugar solutions thereof; examples of nitrogen sources as the yeast assimilable raw material include yeast extracts, soybean proteins, malt, soybeans, yeast extracts, peas, wheat malt, ungerminated cereal grains, and decomposition products thereof. Examples of the ungerminated cereal grains include ungerminated barley, ungerminated wheat, ungerminated rye, ungerminated wild oat, ungerminated oat, ungerminated adlay, and ungerminated common oat, ungerminated rice (such as white rice and brown rice), ungerminated maize, ungerminated kaoliang, ungerminated potato, ungerminated beans (such as soybeans and peas), ungerminated buckwheat, ungerminated sorghum, ungerminated foxtail millet, and ungerminated barnyard millet. In addition, starch obtained from these cereal grains and extracts thereof (extracts) may be used.

Examples of the form of the hops used in one aspect of the present invention include pellet hops, powdered hops, and hops extracts. In addition, as of the hops to be used, examples that may be used include processed hops product such as isomerized hops or reduced hops.

The addition amount of the hops is appropriately prepared, and is preferably from 0.0001 to 1 mass % with respect to the total amount of the wort. In addition, the beer-taste wort including hops as a raw material is a wort that contains an iso-a-acid that is a component derived from hops.

Examples of the sweetener include commercially available saccharified liquids obtained by decomposing cereal-derived starch with an acid, an enzyme or the like, saccharides such as sucrose and commercially available starch syrup, natural sweeteners such as trisaccharides or saccharides that contain more than three monosaccharide units, sugar alcohols, isomerized sugars and stevia, and artificial sweeteners.

These saccharides may be in the form of a liquid, such as a solution, or in the form of a solid, such as a powder.

In addition, there are no particular limitations on the type of cereal grain raw material for starch, starch refining method, and the process conditions, such as hydrolysis with an enzyme or an acid. For example, a saccharide having an increased maltose content ratio may be used by appropriately setting conditions for hydrolysis with an enzyme or an acid. In addition, there can also be used sucrose, fructose, glucose, mannose, arabinose, galactose, xylose, rhamnose, ribose, fucose, lactose, maltose, trehalose, maltotriose, maltotetraose, maltopentaose, isomaltose, isomaltotriose, isomaltotetraose, isomaltopentaose, lactosucrose, 4′-galactosyllactose, 1-kestose, nystose, fructofuranosylnystose, raffinose, stachyose, xylobiose, xylotriose, panose, and solutions (sugar solutions) thereof. Examples of the artificial sweetener include aspartame, acesulfame potassium (acesulfame K), sucralose, and neotame. For these sweeteners, a single type of sweetener may be used alone, or two or more types may be used in combination. As a raw material other than malt, a yeast assimilable sugar (assimilable sugar) can be further added to increase the alcohol content.

Examples of the water-soluble dietary fiber include indigestible dextrin, polydextrose, guar gum decomposition product, pectin, glucomannan, alginic acid, laminarin, fucoidin and carrageenan, and indigestible dextrin or polydextrose is preferable from a point of view of versatility such as stability and safety.

The bitterness is preferably imparted by hops or the like to the beer-taste wort, but a bittering agent or bitterness imparting agents may be further used.

The bittering agent or the bitterness imparting agent is not particularly limited, and there can be used those used as a bitterness imparting agent in normal beers or low-malt beers, and examples thereof include rosemary, lychee, amur cork tree, caraway, juniper berry, sage, salvia rosmarinus, lingzhi mushroom, laurel, lingzhi mushroom, quassin, citrus extract, picrasma wood extract, coffee extract, tea extract, bitter melon extract, lotus embryo extract, candelabra aloe extract, rosemary extract, lychee extract, laurel extract, sage extract, caraway extract, wormwood extract, absinthin, alginic acid, and gallic acid.

The antioxidant is not particularly limited, and there can be used a substance used as an antioxidant in normal beers or low-malt beers, and examples thereof include ascorbic acid, erythorbic acid, and catechin.

The flavoring is not particularly limited, and a typical beer flavoring can be used. The beer flavoring is used for imparting a beer-like flavor, and contains a brewing component produced by fermentation. Therefore, there is little need to add a beer flavoring separately when alcohol fermentation is involved in the beer-taste wort production process, but a beer flavoring may be added as desired.

Examples of the beer flavor include esters and higher alcohols, and specific examples thereof include isoamyl acetate, ethyl acetate, n-propanol (such as 1-propanol), isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methylbutyrate, ethyl n-butyrate, myrcene, citral, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranyl acetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3 (2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octene-3-ol, β-eudesmol, 4-mercapto-4-methylpentane-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, phenethyl alcohol, nerol, citronellol, methyl p-toluate, 1,2,3,5-tetramethylbenzene, triethyl citrate, tributyl citrate, diethyl tartrate, dibutyl malate, perillaldehyde, methylheptenone, lemon myrtle, and cinnamaldehyde.

In the beer-taste wort according to one aspect of the present invention, the content of diacetyl may be 0.001 ppm by mass or more, 0.01 ppm by mass or more, 0.02 ppm by mass or more, 0.03 ppm by mass or more, 0.04 ppm by mass or more, 0.05 ppm by mass or more, 0.06 ppm by mass or more, 0.07 ppm by mass or more, 0.08 ppm by mass or more, 0.09 ppm by mass or more, 0.10 ppm by mass or more, 0.11 ppm by mass or more, 0.12 ppm by mass or more, 0.13 ppm by mass or more, 0.14 ppm by mass or more, 0.15 ppm by mass or more, 0.16 ppm by mass or more, 0.17 ppm by mass or more, 0.18 ppm by mass or more, 0.19 ppm by mass or more, 0.20 ppm by mass or more, 0.25 ppm by mass or more, 0.30 ppm by mass or more, 0.35 ppm by mass or more, or 0.40 ppm by mass or more from a point of view of making a wort for obtaining a beer-taste beverage with a deep taste, and the content of diacetyl may be 0.80 ppm by mass or less, 0.70 ppm by mass or less, 0.60 ppm by mass or less, 0.50 ppm by mass or less, 0.45 ppm by mass or less, 0.40 ppm by mass or less, 0.35 ppm by mass or less, 0.30 ppm by mass or less, 0.25 ppm by mass or less, 0.20 ppm by mass or less, 0.15 ppm by mass or less, 0.10 ppm by mass or less, 0.05 ppm by mass or less, or 0.01 ppm by mass or less from a point of view of making a wort for obtaining a beer-taste beverage having a light and smooth taste.

In the beer-taste wort according to one aspect of the present invention, the content of 2,3-pentanedione may be 0.05 ppm by mass or more, 0.10 ppm by mass or more, 0.15 ppm by mass or more, 0.20 ppm by mass or more, 0.25 ppm by mass or more, 0.30 ppm by mass or more, 0.35 ppm by mass or more, 0.40 ppm by mass or more, 0.45 ppm by mass or more, 0.50 ppm by mass or more, 0.55 ppm by mass or more, or 0.60 ppm by mass or more from a point of view of making a wort for obtaining a beer-taste beverage having a deep taste, and may be 0.80 ppm by mass or less, 0.75 ppm by mass or less, 0.70 ppm by mass or less, 0.65 ppm by mass or less, 0.60 ppm by mass or less, 0.55 ppm by mass or less, 0.50 ppm by mass or less, 0.45 ppm by mass or less, 0.40 ppm by mass or less, 0.35 ppm by mass or less, 0.30 ppm by mass or less, 0.25 ppm by mass or less, 0.20 ppm or less, 0.15 ppm by mass or less, or 0.10 ppm by mass or less from a point of view of making a wort for obtaining a beer-taste beverage having a light and smooth taste.

In the beer-taste wort according to one aspect of the present invention, the content of hydrogen sulfide is preferably 20 ppb by mass or less, 18 ppb by mass or less, 16 ppb by mass or less, 14 ppb by mass or less, 12 ppb by mass or less, 10 ppb by mass or less, 8.0 ppb by mass or less, 6.0 ppb by mass or less, 4.0 ppb by mass or less, 2.0 ppb by mass or less, or 0.0 ppb by mass or less from a point of view of making a wort for obtaining a beer-taste beverage with little unsuitable hot spring scent.

In the beer-taste wort according to one aspect of the present invention, the content of acetaldehyde may be 5.0 mg/L or more, 10 mg/L or more, 15 mg/L or more, 20 mg/L or more, 25 mg/L or more, 30 mg/L or more, 35 mg/L or more, 40 mg/L or more, 45 mg/L or more, or 50 mg/L or more from a point of view of making a wort for obtaining a beer-taste beverage having a deep taste, and may be 50 mg/L or less, 45 mg/L or less, 40 mg/L or less, 35 mg/L or less, 30 mg/L or less, 25 mg/L or less, 20 mg/L or less, 15 mg/L or less, or 10 mg/L or less from a point of view of making a wort for obtaining a beer-taste beverage having a light and smooth taste.

In the beer-taste wort according to one aspect of the present invention, the content of ethyl acetate may be 20 mg/L or more, 25 mg/L or more, 30 mg/L or more, 35 mg/L or more, 40 mg/L or more, 45 mg/L or more, 50 mg/L or more, 55 mg/L or more, 60 mg/L or more, 65 mg/L or more, 70 mg/L or more, 75 mg/L or more, or 80 mg/L or more from a point of view of making a wort for obtaining a beer-taste beverage having a deep taste, and the content of ethyl acetate may be 100 mg/L or less, 95 mg/L or less, 90 mg/L or less, 85 mg/L or less, 80 mg/L or less, 75 mg/L or less, 70 mg/L or less, 65 mg/L or less, 60 mg/L or less, 55 mg/L or less, 50 mg/L or less, 45 mg/L or less, 40 mg/L or less, 35 mg/L or less, or 30 mg/L or less from a point of view of making a wort for obtaining a beer-taste beverage having a light and smooth taste.

In the beer-taste wort according to one aspect of the present invention, the content of 1-propanol may be 20 mg/L or more, 25 mg/L or more, 30 mg/L or more, 35 mg/L or more, 40 mg/L or more, 45 mg/L or more, 50 mg/L or more, 55 mg/L or more, 60 mg/L or more, 65 mg/L or more, or 70 mg/L or more from a point of view of making a wort for obtaining a beer-taste beverage having a deep taste, and may be 80 mg/L or less, 75 mg/L or less, 70 mg/L or less, 65 mg/L or less, 60 mg/L or less, 55 mg/L or less, 50 mg/L or less, 45 mg/L or less, or 40 mg/L or less from a point of view of making a wort for obtaining a beer-taste beverage having a light and smooth taste.

In the beer-taste wort according to one aspect of the present invention, the content of isobutanol may be 20 mg/L or more, 25 mg/L or more, 30 mg/L or more, 35 mg/L or more, 40 mg/L or more, 45 mg/L or more, 50 mg/L or more, 55 mg/L or more, 60 mg/L or more, 65 mg/L or more, or 70 mg/L or more from a point of view of making a wort for obtaining a beer-taste beverage having a deep taste, and may be 80 mg/L or less, 75 mg/L or less, 70 mg/L or less, 65 mg/L or less, 60 mg/L or less, 55 mg/L or less, 50 mg/L or less, 45 mg/L or less, or 40 mg/L or less from a point of view of making a wort for obtaining a beer-taste beverage having a light and smooth taste.

In the beer-taste wort according to one aspect of the present invention, the content of isoamyl acetate may be 0.5 mg/L or more, 1.0 mg/L or more, 2.0 mg/L or more, 3.0 mg/L or more, 4.0 mg/L or more, 5.0 mg/L or more, 6.0 mg/L or more, 7.0 mg/L or more, 8.0 mg/L or more, 8.0 mg/L or more, 9.0 mg/L or more, 10 mg/L or more, 11 mg/L or more, or 12 mg/L or more from a point of view of making a wort for obtaining a beer-taste beverage having a deep taste, and the content of isoamyl acetate may be 20 mg/L or less, 19 mg/L or less, 18 mg/L or less, 17 mg/L or less, 16 mg/L or less, 15 mg/L or less, 14 mg/L or less, 13 mg/L or less, 12 mg/L or less, 11 mg/L or less, 10 mg/L or less, 9.0 mg/L or less, 8.0 mg/L or less, 7.0 mg/L or less, 6.0 mg/L or less, or 5.0 mg/L or less from a point of view of making a wort for obtaining a beer-taste beverage having a light and smooth taste.

In the beer-taste wort according to one aspect of the present invention, the content of ethyl butyrate may be 100 μg/L or more, 150 μg/L or more, 200 μg/L or more, 250 μg/L or more, 300 μg/L or more, 350 μg/L or more, 400 μg/L or more, 450 μg/L or more, 500 μg/L or more, 550 μg/L or more, 600 μg/L or more, 650 μg/L or more, 700 μg/L or more, 750 μg/L or more, or 800 μg/L or more from a point of view of making a wort for obtaining a beer-taste beverage having a deep taste, and the content of ethyl butyrate may be 1000 μg/L or less, 950 μg/L or less, 900 μg/L or less, 850 μg/L or less, 800 μg/L or less, 750 μg/L or less, 700 μg/L or less, 650 μg/L or less, 600 μg/L or less, 550 μg/L or less, 500 μg/L or less, 450 μg/L or less, or 400 μg/L or less from a point of view of making a wort for obtaining a beer-taste beverage having a light and smooth taste.

In the beer-taste wort according to one aspect of the present invention, the content of iso-a-acids may be 10 ppm by mass or more, 15 ppm by mass or more, 20 ppm by mass or more, 25 ppm by mass or more, 30 ppm by mass or more, 35 ppm by mass or more, 40 ppm by mass or more, 45 ppm by mass or more, 50 ppm by mass or more, 55 ppm by mass or more, 60 ppm by mass or more, 65 ppm by mass or more, or 70 ppm by mass or more from a point of view of making a wort for obtaining a full-bodied beer-taste beverage, and may be 100 ppm by mass or less, 95 ppm by mass or less, 90 ppm by mass or less, 85 ppm by mass or less, 80 ppm by mass or less, 75 ppm by mass or less, 70 ppm by mass or less, 65 ppm by mass or less, 60 ppm by mass or less, 55 ppm by mass or less, or 50 ppm by mass or less from a point of view of making a wort for obtaining a light-bodied beer-taste beverage.

The acidulant is not particularly limited as long as it is a substance having sourness. Apart from the above-described phosphoric acid, there can be used citric acid, gluconic acid, tartaric acid, lactic acid, malic acid, phytic acid, acetic acid, succinic acid, glucono-delta-lactone or salts thereof.

Among these acidulants, citric acid, gluconic acid, tartaric acid, lactic acid, malic acid, phytic acid, acetic acid, succinic acid or salts thereof are preferable, malic acid, citric acid, lactic acid, tartaric acid, acetic acid or salts thereof are more preferable, and malic acid, citric acid, lactic acid or salts thereof are particularly preferable. For these acidulants, a single type of acidulant may be used alone, or two or more types may be used in combination. Note that, the acidulant is not limited to an acidulant approved as a food additive, and there may be used acidulants derived from a raw material such as malt, acidulants produced by adjustments of various process conditions, acidulants produced by yeasts, and acidulants to be added from the outside as an additive or the like.

The content of the acidulant in the beer-taste wort according to one aspect of the present invention is preferably from 500 to 10000 ppm by mass, more preferably from 1000 to 9000 ppm by mass, and still more preferably from 2000 to 8000 ppm by mass.

In the beer-taste wort according to one aspect of the present invention, the content of citric acid may be 100 mg/L or more, 150 mg/L or more, 200 mg/L or more, 250 mg/L or more, 300 mg/L or more, 350 mg/L or more, 400 mg/L or more, 450 mg/L or more, 500 mg/L or more, 550 mg/L or more, 600 mg/L or more, 650 mg/L or more, or 700 mg/L or more from a point of view of making a wort for obtaining a beer-taste beverage imparted with a fruits-like sour taste, and the content of citric acid may be 1000 mg/L or less, 950 mg/L or less, 900 mg/L or less, 850 mg/L or less, 800 mg/L or less, 750 mg/L or less, 700 mg/L or less, 650 mg/L or less, 600 mg/L or less, 550 mg/L or less, 500 mg/L or less, 450 mg/L or less, or 400 mg/L or less from a point of view of making a wort for obtaining a beer-taste beverage that is not too sour. The content of citric acid can be measured by a high-performance liquid chromatography (HPLC) method.

In the beer-taste wort according to one aspect of the present invention, the content of pyruvic acid may be 10 mg/L or more, 30 mg/L or more, 50 mg/L or more, 70 mg/L or more, 90 mg/L or more, 100 mg/L or more, 120 mg/L or more, 140 mg/L or more, 160 mg/L or more, 180 mg/L or more, 200 mg/L or more, 220 mg/L or more, 240 mg/L or more, 260 mg/L or more, 280 mg/L or more, or 300 mg/L or more from a point of view of making a wort for obtaining a full-bodied beer-taste beverage, and the content of pyruvic acid is 500 mg/L or less, 480 mg/L or less, 460 mg/L or less, 440 mg/L or less, 420 mg/L or less, 400 mg/L or less, 380 mg/L or less, 360 mg/L or less, 340 mg/L or less, 320 mg/L or less, or 300 mg/L or less from a point of view of making a wort for obtaining a beer-taste beverage that is not too sour. The content of pyruvic acid can be measured by a high-performance liquid chromatography (HPLC) method.

In the beer-taste wort according to one aspect of the present invention, the content of malic acid may be 100 mg/L or more, 150 mg/L or more, 200 mg/L or more, 250 mg/L or more, 300 mg/L or more, 350 mg/L or more, 400 mg/L or more, 450 mg/L or more, 500 mg/L or more, 550 mg/L or more, 600 mg/L or more, 650 mg/L or more, or 700 mg/L or more from a point of view of making a wort for obtaining a beer-taste beverage with good barley taste, and the content of malic acid is 1000 mg/L or less, 950 mg/L or less, 900 mg/L or less, 850 mg/L or less, 800 mg/L or less, 750 mg/L or less, 700 mg/L or less, 650 mg/L or less, 600 mg/L or less, 550 mg/L or less, 500 mg/L or less, 450 mg/L or less, or 400 mg/L or less from a point of view of making a wort for obtaining a beer-taste beverage that is not too sour. As the malic acid, a synthetic malic acid may be used, a fermented malic acid may be used, or a synthetic malic acid and a fermented malic acid may be used in combination. The content of malic acid can be measured by a high-performance liquid chromatography (HPLC) method.

In the beer-taste wort according to one aspect of the present invention, the content of succinic acid may be 50 mg/L or more, 100 mg/L or more, 150 mg/L or more, 200 mg/L or more, 250 mg/L or more, 300 mg/L or more, 350 mg/L or more, or 400 mg/L or more from the point of view of making a wort for obtaining a beer-taste beverage with a complex taste, and may be 500 mg/L or less, 450 mg/L or less, 400 mg/L or less, 350 mg/L or less, 300 mg/L or less, 250 mg/L or less, 200 mg/L or less, 150 mg/L or less, or 100 mg/L or less from the point of view of making a wort for obtaining a beer-taste beverage that is not too sour. The content of succinic acid can be measured by a high-performance liquid chromatography (HPLC) method.

In the beer-taste wort according to one aspect of the present invention, the content of lactic acid may be 50 mg/L or more, 100 mg/L or more, 150 mg/L or more, 200 mg/L or more, 250 mg/L or more, 300 mg/L or more, 350 mg/L or more, 400 mg/L or more, 450 mg/L or more, 500 mg/L or more, 550 mg/L or more, 600 mg/L or more, 650 mg/L or more, 700 mg/L or more, 750 mg/L or more, or 800 mg/L or more from the point of view of making a wort for obtaining a beer-taste beverage having a mellow taste, and the content of lactic acid is 1000 mg/L or less, 950 mg/L or less, 900 mg/L or less, 850 mg/L or less, 800 mg/L or less, 750 mg/L or less, 700 mg/L or less, 650 mg/L or less, 600 mg/L or less, 550 mg/L or less, 500 mg/L or less, 450 mg/L or less, 400 mg/L or less, 350 mg/L or less, or 300 mg/L or less from the point of view of making a wort for obtaining a beer-taste beverage that is not too sour. Note that, as the lactic acid, a synthetic lactic acid may be used, a fermented lactic acid may be used, or a synthetic lactic acid and a fermented lactic acid may be used in combination. The content of lactic acid can be measured by a high-performance liquid chromatography (HPLC) method.

In the beer-taste wort according to one aspect of the present invention, the content of acetic acid may be 50 mg/L or more, 100 mg/L or more, 150 mg/L or more, 200 mg/L or more, 250 mg/L or more, 300 mg/L or more, 350 mg/L or more, or 400 mg/L or more from a point of view of making a wort for obtaining a beer-taste beverage with a crisp taste, and the content of acetic acid may be 500 mg/L or less, 450 mg/L or less, 400 mg/L or less, 350 mg/L or less, 300 mg/L or less, 250 mg/L or less, 200 mg/L or less, 150 mg/L or less, or 100 mg/L or less from a point of view of making a wort for obtaining a beer-taste beverage that is not too sour. The content of acetic acid can be measured by a high-performance liquid chromatography (HPLC) method.

Examples of the preservative include: benzoic acid; benzoic acid salts such as sodium benzoate; benzoic acid esters such as propyl parahydroxybenzoate and butyl parahydroxybenzoate; and dimethyl dicarbonate. In addition, as the preservative, a commercially available formulation such as Strong Samprezer (a mixture of sodium benzoate and butyl benzoate, available from San-Ei Gen F.F.I., Inc.) may be used. For these preservatives, a single type of preservative may be used alone, or two or more types may be used in combination.

The blending amount of the preservative in the beer-taste wort in one aspect of the present invention is preferably from 5 to 1200 ppm by mass, more preferably from 10 to 1100 ppm by mass, still more preferably from 15 to 1000 ppm by mass, and even more preferably from 20 to 900 ppm by mass.

Examples of the salts include sodium chloride, acidic potassium phosphate, acidic calcium phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

For these salts, a single type of salt may be used alone, or two or more types may be used in combination.

### 1.2 Carbon Dioxide Gas

The beer-taste wort of one aspect of the present invention may contain dissolved carbon dioxide gas, or need not contain dissolved carbon dioxide gas.

As the carbon dioxide gas contained in the beer-taste wort, the carbon dioxide gas contained in the ingredients may be used, or carbon dioxide gas may be dissolved by mixing carbonated water, by addition of carbon dioxide gas, or the like.

The beer-taste beverage according to one aspect of the present invention is produced through alcoholic fermentation step, and hence the carbon dioxide gas generated in this fermentation step can be used directly, but the amount of carbon dioxide gas may be prepared by appropriately adding carbonated water.

When the beer-taste wort according to one aspect of the present invention contains dissolved carbon dioxide gas, the concentration of carbon dioxide gas is preferably 0.30 (w/w) % or more, more preferably 0.35 (w/w) % or more, still more preferably 0.40 (w/w) % or more, even more preferably 0.42 (w/w) % or more, and particularly preferably 0.45 (w/w) % or more, and is preferably 0.80 (w/w) % or less, more preferably 0.70 (w/w) % or less, still more preferably 0.60 (w/w) % or less, even more preferably 0.57 (w/w) or less, and particularly preferably 0.55 (w/w) % or less, and may be 0.54 (w/w) % or less, 0.53 (w/w) % or less, 0.52 (w/w) % or less, 0.51 (w/w) % or less, or 0.50 (w/w) % or less.

When the beer-taste wort according to one aspect of the present invention is a wort filled in a container, the carbon dioxide gas pressure in the wort filled in a container needs to be appropriately adjusted so the concentration of carbon dioxide gas as to be within the range set forth above, but the carbon dioxide gas pressure in the wort is 5.0 kg/cm² or lower, 4.5 kg/cm² or lower, or 4.0 kg/cm² or lower, and 0.20 kg/cm² or higher, 0.50 kg/cm² or higher, or 1.0 kg/cm² or higher, and any of these upper limits and any of lower limits may be combined. For example, the carbon dioxide gas pressure in the wort may be 0.20 kg/cm² or higher and 5.0 kg/cm² or lower, 0.50 kg/cm² or higher and 4.5 kg/cm² or lower, or 1.0 kg/cm² or higher and 4.0 kg/cm² or lower.

As used herein, the term “gas pressure” refers to the gas pressure in a container unless otherwise specified.

The pressure can be measured by a method well known to those skilled in the art, for example, by a method in which a sample adjusted to be at 20° C. is fixed to a gas internal pressure gauge, then a stopcock of the gas internal pressure gauge is opened to let off the gas, the stopcock is closed again, and the gas internal pressure gauge is shaken to allow the pointer to stop at a fixed position and the indicated value is read at that time, or the pressure can be measured with a commercially available gas pressure measuring apparatus.

### 1.3 Other Additives

In the beer-taste beverage according to one aspect of the present invention, various additives may be added as necessary to the extent that the effects of the present invention are not compromised.

Examples of such additives include coloring agents, foaming agents, fermentation accelerators, yeast extracts, protein-based substances such as peptide-containing substances, and seasonings such as amino acids.

The coloring agent is used to impart a beer-like color to the beverage, and a caramel dye or the like can be used. The foaming agent is used to form beer-like foams in the beverage or to preserve the foams in the beverage, and there can be appropriately used a saponin-based substance extracted from a plant, such as soybean saponin or quillaja saponin; a plant protein such as from corn or soybean; and a peptide-containing substance such as a collagen peptide; a yeast extract; ingredients derived from milk; or the like.

The fermentation accelerator is used for promoting fermentation by yeasts, and examples thereof include a yeast extract, a bran component from such as rice and wheat, a vitamin, and a mineral agent. A single type of fermentation accelerator can be used alone or two or more types may be used in combination.

### 2. Method for Producing Beer-Taste Wort

The method for producing the beer-taste wort according to one aspect of the present invention is not particularly limited, and the beer-taste wort can be produced in the same manner as a typical beer-taste beverage, but examples thereof include a method having at least the following step (I).

Step (I): Step of adding an enzyme.

The method for producing a beer-taste wort according to one aspect of the present invention is not particularly limited, but may be a method for producing a beer-taste wort through a fermentation step, or may be a method for producing a beer-taste wort with no fermentation step.

Hereinafter, a production method in which a fermented beer-taste wort is produced through a fermentation step and a production method in which a non-fermented beer-taste wort is produced through no fermentation step will be described.

### 2.1 Method for Producing Fermented Beer-Taste Wort

Examples of the method for producing a fermented beer-taste wort according to one aspect of the present invention include a method that includes a fermentation step with yeasts, and for example, the method may have the following steps (1) and (2).
Step (1): a step in which raw materials are subjected to at least one process from the group consisting of a saccharification process, a boiling process, and a solid content removal process and thereby affording a pre-fermentation liquid.
Step (2): a step in which yeasts are added to the pre-fermentation liquid to allow fermentation.

In the method for producing a fermented beer-taste wort according to one aspect of the present invention, the step (I) can be performed at one or more timings of the following (i) to (iii):
(i): At the same time as step (1) and/or step (2)
(ii): In between step (1) and step (2)
(iii): After step (2)

Hereinafter, each step in the method for producing a fermented beer-taste wort according to one aspect of the present invention will be described.

### 2.1.1 Step (1)

Step (1) is a step in which various raw materials are used and at least one process from the group consisting of saccharification process, boiling process, and solid content removal process is carried out to afford a pre-fermentation liquid.

For example, when malt is used as a raw material, various raw materials including water and malt are fed into a mashing kettle or a mashing tank, and an enzyme preparation such as a polysaccharide degrading enzyme or a proteolytic enzyme, which promotes a change of components derived from the raw material, may be added thereto as necessary. This makes it possible to promote the production of assimilable sugars, for example.

Examples of the enzyme preparation include amylase, protease, purine nucleosidase, deaminase, polyphenol oxidase, glucanase, xylase, pectinase, cellulase, lipase, glucosidase, xanthine oxidase, transglucosidase, glucoamylase, uricase, β-glucosidase, and α-glucosidase. These enzyme preparations may be heat-resistant or non-heat-resistant. In addition, the type of enzyme preparation can be selected properly depending on the addition timing or the addition step. Note that, for these enzyme preparations, a single type of enzyme preparation may be used alone, or two or more types may be used in combination. Examples also include enzyme preparations classified in “(3) Following Enzyme Preparations Added during Brewing Step for Purpose of Rationalization of Brewing and the like” in Article 3 “7. Articles not Handled as Raw Materials for Alcoholic Beverages” of the Notice on the Liquor Tax Act and the Administrative Ordinance Related to Alcoholic Beverages (revised on Jun. 27, 2018).

Addition of these enzyme preparations can efficiently adjust the component composition of the resulting beer-taste wort. As various raw materials other than malt, there may be added various additives such as assimilable sugars such as glucose, sucrose, and maltose, hops, preservatives, sweeteners, water-soluble dietary fibers, bittering agents or bitterness imparting agents, antioxidants, flavors, acidulants, and pigments. The enzyme preparation and various raw materials may be added before the saccharification process, may be added during the saccharification process, or may be added after the saccharification process is complete. Moreover, these may be added together with yeasts before and after fermentation in the subsequent step, that is, in step (2), may be added during fermentation, or may be added after fermentation is complete.

A mixture of the various raw materials is heated to cause saccharification of the starches in the raw materials thereby performing saccharification process.

It is preferable to appropriately adjust the temperature and the amount of time for the saccharification process in view of the type of malt to be used, the malt ratio, the type and amount of water and raw materials other than malt, the type and amount of enzyme to be used, the original extract concentration and alcohol content of the finally obtained wort, and the like. For example, in one aspect of the present invention, from a point of view of adjusting the original extract concentration, alcohol content, and the like of the beer-taste wort to be within the range set forth above, it is preferable that the temperature for the saccharification process is within a range from 55 to 75° C., and the amount of time for the saccharification process is within a range from 30 to 240 minutes.

Note that this saccharified liquid is preferably subjected to boiling process.

In a case where hops, a bittering agent, and the like are used as raw materials, they are preferably added at the time when this boiling process is carried out. Hops, a bittering agent, and/or the like may be added in between the start of boiling the saccharified liquid and a time point before the end of the boiling.

After the boiling process is complete, the liquid is transferred to whirlpool and is cooled to 0-25° C. thereby made into a cooled liquid, and then a process for removing a solid content such as coagulated protein is preferably carried out. Through this removal process, the original extract concentration can be adjusted to be within the range set forth above. In this way, a pre-fermentation liquid is prepared.

Note that in this step, there may be performed a filtration through a filter having a predetermined pore diameter (e.g., a pore diameter less than 30 μm) to perform a process for removing a solid content.

In place of the saccharified liquid, a malt extract added with hot water may be used, and this liquid is added with hops, a bittering agent and the like and then subjected to boiling process to prepare a pre-fermentation liquid.

When no malt is used or an limited amount of malt is used as the various raw materials, a liquid sugar that contains a carbon source, a nitrogen source as an amino acid-containing raw material other than wheat or barley or malt, hops, a dietary fiber, a preservative, a sweetener, an antioxidant, a bitterness imparting agent, a flavor, an acidulant, a pigment, and the like are mixed with hot water to prepare a liquid sugar solution, and this liquid sugar solution may be subjected to boiling process to prepare a pre-fermentation liquid.

When hops are used, hops may be added before the boiling process or may be added in between the start of boiling the liquid sugar solution and at a time point before the end of the boiling.

### 2.1.2 Step (2)

Step (2) is a step in which yeasts are added to the pre-fermentation liquid obtained in step (1) to perform fermentation.

The yeast used in this step can be appropriately selected in view of the type of the fermented beverage to be produced, the target flavor, the fermentation conditions, and the like, and top-fermenting yeast may be used, or bottom-fermenting yeast may be used.

As for yeasts, a yeast suspension may be directly added to the raw material, or a slurry of yeasts concentrated by centrifugation or sedimentation may be added to the pre-fermentation liquid. Alternatively, a concentrate of yeasts from which the supernatant has been completely removed after the centrifugation may be added. The amount of yeast to be added to the wort can be appropriately set, and is, for example, in a range from about 5×10⁶ cells/mL to 1×10⁸ cells/mL.

The fermentation conditions during performing fermentation can be appropriately set, but the fermentation temperature is preferably in a range from 5 to 25° C. from a point of view of adjusting the original extract concentration and alcohol content of the beer-taste wort to be within the range set forth above. In addition, the original extract concentration and the alcohol content of the beer-taste wort can be adjusted by appropriately setting the type, addition amount of enzyme, and the timing for enzyme addition listed in the section “2.2.1 Step (1)”, and the temperature (temperature increase or temperature decrease) or pressure of the fermentation liquid may be changed in the fermentation step as necessary.

After the fermentation, a filtration process for removing yeasts in the beer-taste wort may be performed, or the filtration process need not be performed. In addition, water or the above-described various additives may be added as necessary. Furthermore, in order to adjust the invertase activity value to be within the range set forth above, heat treatment of the beer-taste wort may be performed.

Moreover, in the step (2), a maturing process may be performed after the fermentation liquid is obtained (maturation step). After the fermentation liquid is obtained, the maturation may be carried out at any stage before moving to the subsequent steps (3) or (4), and the maturation may be carried out in a metal tank (e.g., a stainless steel tank) or in a wooden tank (e.g., a wooden barrel). The maturation period can be for a time period ranging from 1 day to 2 weeks, from 3 days to 2 weeks, from 3 to 7 days, or the like, for example. Through the maturation step, flavor components (such as diacetyl) unsuitable for the beer-taste wort can be reduced.

### 2.1.3 Step (3), Step (4)

In one aspect of the present invention, when the non-alcoholic fermented beer-taste wort is produced, the non-alcoholic fermented beer-taste wort may be produced through a step of non-alcoholic fermentation using a yeast that does not produce alcohol. In this case, a yeast that does not produce alcohol need to be used in the step (2).

In addition, in the case of producing a non-alcoholic fermented beer-taste wort using a yeast that produces alcohol, steps (3) and (4) are preferably carried out additionally together with steps (1) to (2) described above.
Step (3): a step of removing an alcohol content from the fermentation liquid after the step (2).
Step (4): a step of adjusting the amount of carbon dioxide gas after the step (3).

In the step (3), as a method for removing the alcohol content produced in the fermentation step of the step (2), a method for removing the alcohol content by heat treatment is preferable. As conditions for the heat treatment, conditions similar to those in a general method for producing a non-alcohol beer-taste beverage can be applied.

After the step (3), the alcohol content has been removed from the solution and carbon dioxide gas has been also removed. Therefore, the amount of carbon dioxide gas is preferably adjusted by the step (4).

As a method for adjusting the amount of carbon dioxide gas, carbon dioxide gas may be added by mixing the solution after step (3) with carbonated water, or carbon dioxide gas may be directly added to the solution that has undergone step (3).

The thus obtained beer-taste wort of one aspect of the present invention undergoes a sterilization process as necessary, and then is filled in a predetermined container, and distributed to the market as a product.

The method for filling the beer-taste wort into a container is not particularly limited, and a container filling method known to those skilled in the art can be used. Through the container filling step, the beer-taste wort of the present invention is filled into a container and sealed. In the container filling step, a container of any form/material may be used, and examples of the container are as described above.

### 2.2 Method for Producing Non-Fermented Beer-Taste Wort

When the beer-taste wort as one aspect of the present invention is a non-fermented beer-taste wort, the beer-taste wort can be produced by a general method for producing a non-fermented beer-taste beverage. Specific examples of the method for producing a non-fermented beer-taste wort according to one aspect of the present invention include a method having the following steps (a) to (b).
Step (a): a step in which a raw material undergoes at least one process of the group of a saccharification process, a boiling process, and a solid content removal process and a pre-beverage liquid is obtained.
Step (b): a step in which the pre-beverage liquid obtained in step (a) is cooled and carbon dioxide gas is added thereto.

The step (a) is the same as the step of giving the pre-fermentation liquid of the step (1) in the section “Method for producing fermented beer-taste wort” described above.

As a method for adding carbon dioxide gas in the step (b), the pre-fermentation liquid obtained in the step (a) is cooled and this cooled pre-fermentation liquid may be mixed with carbonated water thereby adding carbon dioxide gas, or carbon dioxide gas may be directly added to the cooled fermentation wort. At the same timing as the step (b), additives such as a preservative, a sweetener, a flavoring, an acidulant, and a pigment may be added as necessary in adding carbon dioxide gas.

When the non-fermented beer-taste wort is made into a non-fermented alcohol-containing beer-taste wort, the following step (c) is included.
Step (c): an alcohol component is blended at least after the step (a).

The step (c) needs to be performed at least after the step (a), and can be performed, for example, at one or more timings of any of the following (I) to (III).
(I): In between the step (a) and the step (b)
(II): At the same time as the step (b)
(III): After the step (b)

Among them, the step (c) is preferably performed after the pre-fermentation liquid obtained in the step (a) is cooled to adjust a cooled fermentation wort and before adding carbon dioxide gas.

As the alcohol component to be blended in the step (c), spirits (a distilled liquor) derived from the above-described cereal grains is preferable.

The thus obtained non-fermented beer-taste wort is filled in a predetermined container and distributed to the market as a product.

The method for filling the non-fermented beer-taste wort into a container is not particularly limited, and a container filling method known to those skilled in the art can be used. Through the container filling step, the non-fermented beer-taste wort is filled into a container and sealed. In the container filling step, a container of any form/material may be used, and examples of the container include those described above.

### 3. Method for Producing Beer-Taste Beverage

One aspect of the present invention also relates to a method for producing a beer-taste beverage, the method including mixing the aforesaid beer-taste wort and an edible aqueous solution. The addition amount of the edible aqueous solution may be twice or more, three times or more, four times or more, five times or more, six times or more, seven times or more, eight times or more, nine times or more, or ten times or more, and may be ten times or less, nine times or less, eight times or less, seven times or less, six times or less, five times or less, four times or less, three times or less, or twice or less as much as the amount of the beer-taste wort of one aspect of the present invention. Note that the edible aqueous solution is as described above in the section “1. Beer-taste wort”.

The resultant beer-taste beverage may be directly provided for consumption, or may be filled in a container in the same manner as the beer-taste wort and distributed to the market as a product.

### EXAMPLES

Hereinafter, the present invention will be described in more detail by examples and the like, but the present invention is not limited by these examples.

### [Example A] Evaluation of Beer-Taste Wort

### <Preparation of Beer-Taste Wort>

Milled barley malt was fed into a mashing tank containing 120 L of hot water, and then the temperature was increased stepwise and maintained, followed by filtration to remove malt lees and the like. After the filtration, the raw material liquid, sugar solution, and hops were fed into a boiling pot and hot water was added thereto to adjust the volume to 100 L and a hot wort was obtained. The resultant hot wort was cooled, and aeration with oxygen was performed to afford 60 L of pre-fermentation liquid before yeast addition.

Beer yeast (top-fermenting yeast) was added to the thus obtained pre-fermentation liquid and a fermentation temperature and a fermentation time were adjusted, thereby performing alcohol fermentation so a predetermined original extract concentration and alcohol content as to be achieved, and then the yeast was removed by filtration to prepare a beer-taste wort. Note that, no spirits were added in all Examples and Comparative Examples.

The malt ratios in Examples and Comparative Examples were as shown in Tables 1 to 3. In addition, an enzyme was added and heat treatment was performed except for Examples 1, 4, 7, and 11 and Comparative Example 1 to 3. The invertase activity values of the beer-taste wort of Examples 1, 4, 7, and 11 and Comparative Example 1 to 3 were found to be more than 55 units, and the invertase activity values of the beer-taste wort other than Examples 1, 4, 7, and 11 and Comparative Example 1 to 3 were found to be 55 units or less.

### <Sensory Evaluation>

The resultant beer-taste wort was cooled to about 4° C., whose scent was smelled by same six panelists, and the evaluation item “grain odor derived from malt unsuitable for the beer-taste wort” was rated as follows.

That is, based on the following score criteria, the odor was rated with scores in increments of 0.1 in the range from 1.0 (minimum value) to 3.0 (maximum value), and the average value of scores by the six panelists was calculated.

In the evaluation, samples whose evaluation items respectively correspond to the scores of “1.0”, “1.5”, “2.0”, “2.5”, and “3.0” in the following criteria were prepared in advance, and uniformity of standards among the panelists was attempted. Incidentally, in sensory evaluation of all Examples and Comparative Examples, there was no difference of 0.2 or more confirmed between score values among panelists for the same sample. Note that, there was no panelist who gave a score less than 2.0 for Examples with overall evaluation of “A” or “B”.

[Grain Odor Derived from Malt Unsuitable for Beer-Taste Wort]
“3.0”: Grain odor derived from malt unsuitable for the beer-taste wort is totally imperceptible.
“2.5”: Grain odor derived from malt unsuitable for the beer-taste wort is almost imperceptible.
“2.0”: Grain odor derived from malt unsuitable for the beer-taste wort is barely perceptible.
“1.5”: A grain odor derived from malt unsuitable for a beer-taste wort is perceptible.
“1.0”: A grain odor derived from malt unsuitable for a beer-taste wort is strongly perceptible.
   [Overall evaluation]
“A”: The average score of the sensory evaluation items is 2.2 or more.
“B”: The average score of the sensory evaluation item is 2.0 or more and less than 2.2.
“C”: The average score of the sensory evaluation item is less than 2.0.

TABLE 1

| | | Com- | Exam- | Exam- | Exam- | Com- | Exam- | Exam- | Exam- | Com- | Exam- |
|---|---|---|---|---|---|---|---|---|---|---|---|
| | | parative | ple | ple | ple | parative | ple | ple | ple | parative | ple |
| | | Example 1 | 1 | 2 | 3 | Example 2 | 4 | 5 | 6 | Example 3 | 7 |
| Malt ratio | mass % | 100 | 100 | 55 | 55 | 100 | 100 | 55 | 55 | 55 | 55 |
| Original extract | mass % | 20.0 | 20.0 | 20.0 | 20.0 | 28.0 | 28.0 | 28.0 | 28.0 | 32.0 | 32.0 |
| concentration | | | | | | | | | | | |
| Alcohol content | v/v % | 7.32 | 9.93 | 10.95 | 11.95 | 10.78 | 11.55 | 14.52 | 16.67 | 12.65 | 13.53 |
| Original extract | — | 2.73 | 2.01 | 1.83 | 1.67 | 2.60 | 2.42 | 1.93 | 1.68 | 2.53 | 2.36 |
| concentration | | | | | | | | | | | |
| (B)/alcohol | | | | | | | | | | | |
| content (A) | | | | | | | | | | | |

| | | | | | | | | | | |
|---|---|---|---|---|---|---|---|---|---|---|
| Grain odor unsuitable | 1.5 | 2.4 | 2.8 | 3.0 | 1.7 | 2.1 | 2.6 | 2.9 | 1.8 | 2.1 |
| for beer-taste wort | | | | | | | | | | |
| Overall evaluation | C | A | A | A | C | B | A | A | C | B |

TABLE 2

| | | Example | Example | Example | Example | Example | Example | Example |
|---|---|---|---|---|---|---|---|---|
| | | 8 | 9 | 10 | 11 | 12 | 13 | 14 |
| Malt ratio | mass % | 100 | 55 | 55 | 55 | 100 | 55 | 55 |
| Original extract | mass % | 32.0 | 32.0 | 32.0 | 39.0 | 39.0 | 39.0 | 39.0 |
| concentration | | | | | | | | |
| Alcohol content | v/v % | 16.97 | 18.62 | 19.43 | 17.26 | 21.51 | 23.54 | 25.51 |
| Original extract | — | 1.89 | 1.72 | 1.65 | 2.26 | 1.81 | 1.66 | 1.53 |
| concentration (B)/ | | | | | | | | |
| alcohol content (A) | | | | | | | | |

| | | | | | | | |
|---|---|---|---|---|---|---|---|
| Grain odor unsuitable for | 2.7 | 2.8 | 2.9 | 2.2 | 2.8 | 2.9 | 2.9 |
| beer-taste wort | | | | | | | |
| Overall evaluation | A | A | A | A | A | A | A |

TABLE 3

| | | Example | Example | Example | Example |
|---|---|---|---|---|---|
| | | 15 | 16 | 17 | 18 |
| Malt ratio | mass % | 80 | 40 | 80 | 40 |
| Original extract concentration | mass % | 28.0 | 28.0 | 32.0 | 32.0 |
| Alcohol content | v/v % | 17.09 | 17.37 | 18.62 | 20.23 |
| Original extract concentration | — | 1.64 | 1.61 | 1.72 | 1.58 |
| (B)/alcohol content (A) | | | | | |

| | | | | |
|---|---|---|---|---|
| Grain odor unsuitable for beer-taste wort | 2.9 | 2.9 | 2.8 | 2.9 |
| Overall evaluation | A | A | A | A |

### [Example B] Evaluation of Beer-Taste Beverage

### <Preparation of Beer-Taste Beverage>

In accordance with the method of Example A described above, beer-taste wort of each of Examples and Comparative Examples shown in the following Tables 4 to 6 was prepared. In this preparation, an enzyme was added and a heat treatment was performed in all Examples. In all Examples, the beer-taste wort had an invertase activity value of 55 units or less. Note that, no spirits were added in all Examples.

The resultant beer-taste wort was mixed with carbonated water by a dilution factor indicated in each table to afford a beer-taste beverage.

In the following Tables 4 to 6, the contents of “Total nitrogen amount”, “Total polyphenol amount”, “Free amino nitrogen”, and “Phosphoric acid” refers to the contents in the beer-taste wort.

### <Sensory Evaluation>

The resultant beer-taste beverage was cooled to about 4° C., and tasted by the same six panelists, and evaluation items of “Full-bodied taste suitable for beer-taste beverages”, “Refreshing taste suitable for beer-taste beverages”, “Crisp taste suitable for beer-taste beverages”, and “Stimulating taste suitable for beer-taste beverages” were rated as follows.

That is, based on the following score criteria, the tastes were rated with scores in increments of 0.1 in the range from 1.0 (minimum value) to 3.0 (maximum value), and the average value of scores by the six panelists was calculated.

In the evaluation, samples whose evaluation items respectively correspond to the scores of “1.0”, “1.5”, “2.0”, “2.5”, and “3.0” in the following criteria were prepared in advance, and uniformity of standards among the panelists was attempted. Incidentally, in sensory evaluation of all Examples, there was no difference of 0.2 or more confirmed between score values among panelists for the same sample. Note that, there was no panelist who gave a score less than 2.0 for Examples with overall evaluation of “A” or “B”.

### [Full-Bodied Taste Suitable for Beer-Taste Beverages]

“3.0”: Full-bodied taste suitable for beer-taste beverages is intensely perceivable.
“2.5”: Full-bodied taste suitable for beer-taste beverages is strongly perceivable.
“2.0”: Full-bodied taste suitable for beer-taste beverages is perceivable.
“1.5”: Full-bodied taste suitable for beer-taste beverages is barely perceptible.
“1.0”: Full-bodied taste suitable for beer-taste beverages is almost imperceptible.

### [Refreshing Taste Suitable for Beer-Taste Beverages]

“3.0”: Refreshing taste suitable for beer-taste beverages is intensely perceivable.
“2.5”: Refreshing taste suitable for beer-taste beverages is strongly perceivable.
“2.0”: Refreshing taste suitable for beer-taste beverages is perceivable.
“1.5”: Refreshing taste suitable for beer-taste beverages is barely perceptible.
“1.0”: Refreshing taste suitable for beer-taste beverages is almost imperceptible.

### [Crisp Taste Suitable for Beer-Taste Beverages]

“3.0”: Crisp taste suitable for beer-taste beverages is intensely perceivable.
“2.5”: Crisp taste suitable for beer-taste beverages is strongly perceivable.
“2.0”: Crisp taste suitable for beer-taste beverages is perceivable.
“1.5”: Crisp taste suitable for beer-taste beverages is barely perceptible.
“1.0”: Crisp taste suitable for beer-taste beverages is almost imperceptible.

### [Stimulating Taste Suitable for Beer-Taste Beverages]

“3.0”: Stimulating taste suitable for beer-taste beverages is intensely perceivable.
“2.5”: Stimulating taste suitable for beer-taste beverages is strongly perceivable.
“2.0”: Stimulating taste suitable for beer-taste beverages is perceivable.
“1.5”: Stimulating taste suitable for beer-taste beverages is barely perceptible.
“1.0”: Stimulating taste suitable for beer-taste beverages is almost imperceptible.

### [Overall Evaluation]

“A”: All of the average scores of the validated sensory evaluation items in each table are 2.2 or more.
“B”: Not corresponding to “A” or “C”.
“C”: One or more of any of the average scores of the validated sensory evaluation items in each table are less than 2.0.

TABLE 4

| | | Ex- | Ex- | Ex- | Ex- | Ex- | Ex- | Ex- | Ex- |
|---|---|---|---|---|---|---|---|---|---|
| | | am- | am- | am- | am- | am- | am- | am- | am- |
| 4-fold | | ple | ple | ple | ple | ple | ple | ple | ple |
| dilution | | 6 | 19 | 20 | 15 | 21 | 22 | 16 | 23 |
| Malt ratio | mass % | 55 | 55 | 55 | 80 | 80 | 80 | 40 | 40 |
| Original extract | mass % | 28.0 | 28.0 | 28.0 | 28.0 | 28.0 | 28.0 | 28.0 | 28.0 |
| concentration | | | | | | | | | |
| Alcohol content | v/v % | 16.67 | 16.69 | 16.68 | 17.09 | 17.11 | 17.12 | 17.37 | 17.29 |
| Original extract | — | 1.68 | 1.68 | 1.68 | 1.64 | 1.64 | 1.64 | 1.61 | 1.62 |
| concentration | | | | | | | | | |
| (B)/alcohol | | | | | | | | | |
| content (A) | | | | | | | | | |
| Total nitrogen | mg/100 mL | 119 | 171 | 100 | 161 | 242 | 139 | 70 | 105 |
| amount | | | | | | | | | |
| Total polyphenol | ppm by mass | 288 | 260 | 265 | 390 | 390 | 390 | 180 | 180 |
| amount | | | | | | | | | |
| Free amino | mg/100 mL | 21 | 21 | 21 | 31 | 31 | 31 | 13 | 13 |
| nitrogen content | | | | | | | | | |
| Phosphoric acid | mg/L | 937 | 941 | 944 | 1299 | 1319 | 1388 | 612 | 633 |
| content | | | | | | | | | |

| | | | | | | | | |
|---|---|---|---|---|---|---|---|---|
| Full-bodied taste suitable for | 2.4 | 2.7 | 2.3 | 2.6 | 3.0 | 2.5 | 2.2 | 2.3 |
| beer-taste beverages | | | | | | | | |
| Refreshing taste suitable for | 2.5 | 2.5 | 2.5 | 2.2 | 2.2 | 2.2 | 2.9 | 2.9 |
| beer-taste beverages | | | | | | | | |
| Crisp taste suitable for beer- | 2.6 | 2.6 | 2.6 | 2.1 | 2.1 | 2.1 | 2.9 | 2.9 |
| taste beverages | | | | | | | | |
| Stimulating taste suitable for | 2.5 | 2.5 | 2.5 | 2.9 | 2.9 | 2.9 | 2.2 | 2.3 |
| beer-taste beverages | | | | | | | | |
| Overall evaluation | A | A | A | B | B | B | A | A |

| | | Ex- | Ex- | Ex- | Ex- | Ex- | Ex- | Com- |
|---|---|---|---|---|---|---|---|---|
| | | am- | am- | am- | am- | am- | am- | parative |
| 4-fold | | ple | ple | ple | ple | ple | ple | Exam- |
| dilution | | 24 | 25 | 26 | 27 | 28 | 29 | ple 4 |
| Malt ratio | mass % | 40 | 40 | 55 | 55 | 80 | 40 | 30 |
| Original extract | mass % | 28.0 | 20.0 | 39.0 | 32.0 | 32.0 | 32.0 | 20 |
| concentration | | | | | | | | |
| Alcohol content | v/v % | 17.39 | 9.91 | 25.33 | 19.22 | 18.55 | 20.21 | 7.86 |
| Original extract | — | 1.61 | 2.02 | 1.54 | 1.66 | 1.73 | 1.58 | 2.54 |
| concentration | | | | | | | | |
| (B)/alcohol | | | | | | | | |
| content (A) | | | | | | | | |
| Total nitrogen | mg/100 mL | 60 | 57 | 166 | 136 | 181 | 91 | 41 |
| amount | | | | | | | | |
| Total polyphenol | ppm by mass | 180 | 137 | 401 | 329 | 439 | 219 | 100 |
| amount | | | | | | | | |
| Free amino | mg/100 mL | 13 | 10 | 29 | 24 | 32 | 16 | 7.1 |
| nitrogen content | | | | | | | | |
| Phosphoric acid | mg/L | 625 | 446 | 1305 | 1071 | 1428 | 714 | 310 |
| content | | | | | | | | |

| | | | | | | | |
|---|---|---|---|---|---|---|---|
| Full-bodied taste suitable for | 2.1 | 2.1 | 2.6 | 2.5 | 2.7 | 2.3 | 1.8 |
| beer-taste beverages | | | | | | | |
| Refreshing taste suitable for | 2.9 | 3.0 | 2.2 | 2.4 | 2.1 | 2.8 | 3.0 |
| beer-taste beverages | | | | | | | |
| Crisp taste suitable for beer- | 2.9 | 3.0 | 2.2 | 2.4 | 2.1 | 2.8 | 3.0 |
| taste beverages | | | | | | | |
| Stimulating taste suitable for | 2.3 | 2.1 | 2.9 | 2.7 | 3.0 | 2.3 | 1.8 |
| beer-taste beverages | | | | | | | |
| Overall evaluation | B | B | A | A | B | A | C |

TABLE 5

| | | Exam- | Exam- | Exam- | Exam- | Exam- | Exam- | Exam- |
|---|---|---|---|---|---|---|---|---|
| | | ple | ple | ple | ple | ple | ple | ple |
| 5-fold dilution | | 6 | 19 | 20 | 15 | 26 | 27 | 28 |
| Malt ratio | mass % | 55 | 55 | 55 | 80 | 55 | 55 | 80 |
| Original extract concentration | mass % | 28.0 | 28.0 | 28.0 | 28.0 | 39.0 | 32.0 | 32.0 |
| Alcohol content | v/v % | 16.67 | 16.69 | 16.68 | 17.09 | 25.33 | 19.22 | 18.55 |
| Original extract concentration | — | 1.68 | 1.68 | 1.68 | 1.64 | 1.54 | 1.66 | 1.73 |
| (B)/alcohol content (A) | | | | | | | | |
| Total nitrogen amount | mg/100 mL | 119 | 171 | 100 | 161 | 166 | 136 | 181 |
| Total polyphenol amount | ppm by mass | 288 | 260 | 265 | 390 | 401 | 329 | 439 |
| Free amino nitrogen content | mg/100 mL | 21 | 21 | 21 | 31 | 29 | 24 | 32 |
| Phosphoric acid content | mg/L | 937 | 941 | 944 | 1299 | 1305 | 1071 | 1428 |

| | | | | | | | |
|---|---|---|---|---|---|---|---|
| Full-bodied taste suitable for beer-taste beverages | 2.3 | 2.5 | 2.2 | 2.4 | 2.4 | 2.3 | 2.5 |
| Refreshing taste suitable for beer-taste beverages | 2.6 | 2.6 | 2.7 | 2.3 | 2.4 | 2.5 | 2.2 |
| Crisp taste suitable for beer-taste beverages | 2.7 | 2.7 | 2.7 | 2.3 | 2.3 | 2.5 | 2.2 |
| Stimulating taste suitable for beer-taste beverages | 2.3 | 2.3 | 2.3 | 2.7 | 2.7 | 2.5 | 2.8 |
| Overall evaluation | A | A | A | A | A | A | B |

TABLE 6

| | | Exam- | Exam- | Exam- | Exam- | Exam- | Exam- | Exam- |
|---|---|---|---|---|---|---|---|---|
| | | ple | ple | ple | ple | ple | ple | ple |
| 6-fold dilution | | 6 | 19 | 20 | 15 | 26 | 27 | 28 |
| Malt ratio | mass % | 55 | 55 | 55 | 80 | 55 | 55 | 80 |
| Original extract concentration | mass % | 28.0 | 28.0 | 28.0 | 28.0 | 39.0 | 32.0 | 32.0 |
| Alcohol content | v/v % | 16.67 | 16.69 | 16.68 | 17.09 | 25.33 | 19.22 | 18.55 |
| Original extract concentration | — | 1.68 | 1.68 | 1.68 | 1.64 | 1.54 | 1.66 | 1.73 |
| (B)/alcohol content (A) | | | | | | | | |
| Total nitrogen amount | mg/100 mL | 119 | 171 | 100 | 161 | 166 | 136 | 181 |
| Total polyphenol amount | ppm by mass | 288 | 260 | 265 | 390 | 401 | 329 | 439 |
| Free amino nitrogen content | mg/100 mL | 21 | 21 | 21 | 31 | 29 | 24 | 32 |
| Phosphoric acid content | mg/L | 937 | 941 | 944 | 1299 | 1305 | 1071 | 1428 |

| | | | | | | | |
|---|---|---|---|---|---|---|---|
| Full-bodied taste suitable for beer-taste | 2.2 | 2.4 | 2.1 | 2.3 | 2.3 | 2.2 | 2.4 |
| beverages | | | | | | | |
| Refreshing taste suitable for beer-taste beverages | 2.7 | 2.7 | 2.8 | 2.4 | 2.5 | 2.6 | 2.3 |
| Crisp taste suitable for beer-taste beverages | 2.8 | 2.8 | 2.8 | 2.4 | 2.4 | 2.6 | 2.3 |
| Stimulating taste suitable for beer-taste | 2.1 | 2.1 | 2.2 | 2.5 | 2.5 | 2.4 | 2.7 |
| beverages | | | | | | | |
| Overall evaluation | B | B | B | A | A | A | A |

### [Example C] Evaluation of Beer-Taste Wort and Beer-Taste Beverage

Beer-taste wort having a malt ratio of 40 to 80% of each of Examples 29 and 30 and Examples 31 to 33 having the compositions shown in Tables 7 and 8 below was appropriately prepared in accordance with the method of Example A. When the resultant beer-taste wort was subjected to sensory evaluation in the same manner as in Example A, the average score of the six panelists regarding “Grain odor derived from malt unsuitable for beer-taste wort” was 2.8 or more in Examples 29 and 30, while 2.7 or more in Examples 31 to 33.

In addition, the resultant beer-taste wort was diluted by a factor of 2, 3, 4, 5, and 6 to prepare beer-taste beverages, and the beer-taste beverages were subjected to sensory evaluation in the same manner as in Example B. As a result, the average score of the six panelists was 2.1 or more for all the evaluation items regarding “Full-bodied taste suitable for beer-taste beverages”, “Refreshing taste suitable for beer-taste beverages”, “Crisp taste suitable for beer-taste beverages”, and “Stimulating taste suitable for beer-taste beverages” in all of Examples.

TABLE 7

| | | Example 29 | Example 30 |
|---|---|---|---|
| Original extract concentration | mass % | 28.2 | 28.0 |
| Real extract concentration | mass % | 4.88 | 5.57 |
| Apparent attenuation | % | 101.8 | 98.6 |
| Alcohol content | v/v % | 16.68 | 16.09 |
| pH | — | 4.47 | 4.44 |
| Chromaticity | EBC | 35.6 | 36.8 |
| Bitterness units | BUs | 56.5 | 41.6 |
| Free amino nitrogen content | mg/100 mL | 25.0 | 15.0 |
| Total nitrogen amount | mg/100 mL | 130 | 110 |
| Total polyphenol amount | ppm by mass | 300 | 200 |
| Diacetyl | ppm by mass | 0.15 | 0.12 |
| 2,3-pentanedione | ppm by mass | 0.50 | 0.30 |
| Hydrogen sulfide | ppb by mass | 1.0 | 3.0 |
| Total turbidity (T-Haze) | Helm | 150 | 110 |
| Carbon dioxide | w/w % | 0.48 | 0.50 |
| Acetaldehyde | mg/L | 15.9 | 15.2 |
| Ethyl acetate | mg/L | 73.7 | 53.5 |
| 1-Propanol | mg/L | 48.7 | 38.8 |
| i-Butanol | mg/L | 47.7 | 37.8 |
| Isoamyl acetate | mg/L | 5.8 | 3.1 |
| Ethyl butyrate | ug/L | 472 | 406 |
| Iso-α-acids | ppm by mass | 50.15 | 38.02 |
| Phosphoric acid | mg/L | 937 | 911 |
| Citric acid | mg/L | 411 | 334 |
| Pyruvic acid | mg/L | 151 | 96 |
| Malic acid | mg/L | 407 | 449 |
| Succinic acid | mg/L | 223 | 186 |
| Lactic acid | mg/L | 298 | 245 |
| Acetic acid | mg/L | 371 | 284 |
| Pyroglutamic acid | mg/L | 358 | 277 |
| Proline content | μmol/l | 6172 | 4136 |
| Original extract concentration | — | 1.69 | 1.74 |
| (B)/alcohol content (A) | | | |

TABLE 8

| | | Example 31 | Example 32 | Example 33 |
|---|---|---|---|---|
| Original extract concentration | mass % | 20.9 | 20.5 | 33.0 |
| Real extract concentration | mass % | 3.72 | 4.80 | 5.91 |
| Apparent attenuation | % | 102.0 | 95.0 | 103.0 |
| Alcohol content | v/v % | 11.71 | 10.73 | 19.80 |
| pH | — | 4.41 | 4.55 | 4.48 |
| Chromaticity | EBC | 20.2 | 23.9 | 41.0 |
| Bitterness units | BUS | 34.0 | 27.0 | 66.0 |
| Free amino nitrogen content | mg/100 mL | 15.1 | 13.1 | 29.0 |
| Total nitrogen amount | mg/100 mL | 83 | 71 | 152 |
| Total polyphenol amount | ppm by mass | 190 | 130 | 350 |
| Diacetyl | ppm by mass | 0.18 | 0.11 | 0.16 |
| 2,3-pentanedione | ppm by mass | 0.51 | 0.33 | 0.59 |
| Hydrogen sulfide | ppb by mass | 3.9 | 1.6 | 3.8 |
| Total turbidity (T-Haze) | Helm | 81 | 90 | 179 |
| Carbon dioxide | w/w % | 0.53 | 0.50 | 0.54 |
| Acetaldehyde | mg/L | 10.2 | 10.3 | 19.2 |
| Ethyl acetate | mg/L | 42.5 | 41.9 | 88.0 |
| 1-Propanol | mg/L | 31.1 | 26.8 | 57.0 |
| i-Butanol | mg/L | 30.1 | 24.1 | 55.8 |
| Isoamyl acetate | mg/L | 3.5 | 1.8 | 6.9 |
| Ethyl butyrate | ug/L | 301 | 269 | 552 |
| Iso-α-acids | ppm by mass | 30.10 | 25.10 | 60.90 |
| Phosphoric acid | mg/L | 595 | 592 | 1001 |
| Citric acid | mg/L | 261 | 217 | 480 |
| Pyruvic acid | mg/L | 96 | 64 | 178 |
| Malic acid | mg/L | 251 | 299 | 475 |
| Succinic acid | mg/L | 141 | 120 | 261 |
| Lactic acid | mg/L | 220 | 210 | 349 |
| Acetic acid | mg/L | 233 | 184 | 433 |
| Pyroglutamic acid | mg/L | 220 | 180 | 419 |
| Proline content | μmol/l | 3967 | 2600 | 7217 |
| Original extract concentration (B)/ | — | 1.78 | 1.91 | 1.67 |
| alcohol content (A) | | | | |

From the results in Tables 1 to 3, 7, and 8, the beer-taste wort having a ratio [(B) (A)] of the original extract concentration (in mass %) (B) to the alcohol content (in v/v %) (A) of 2.50 or less was found to have a little unsuitable grain odor derived from malt. Moreover, from the results in Table 4 to 8, the beer-taste beverage prepared by using the beer-taste wort in which the ratio of the original extract concentration to the alcohol content was within the range set forth above was found to be a beer-taste beverage excellent in full-bodied, refreshing, crisp, and stimulating tastes.

1. A beer-taste wort, having a ratio [(B)/(A)] of an original extract concentration (in mass %) (B) to an alcohol content (in (v/v) %) (A) of 2.50 or less.

2. The beer-taste wort according to claim 1, wherein the original extract concentration is 15.0 mass % or more and 50.0 mass % or less.

3. The beer-taste wort according to claim 1, wherein the alcohol content is 8.00 (v/v) % or more.

4. The beer-taste wort according to claim 1, wherein the alcohol content is 50.00 (v/v) % or less.

5. The beer-taste wort according to claim 1, wherein a malt ratio of the beer-taste wort is 30 mass % or more.

6. The beer-taste wort according to claim 1, wherein a total nitrogen amount of the beer-taste wort is 45 mg/100 mL or more.

7. The beer-taste wort according to claim 1, wherein a total polyphenol amount of the beer-taste wort is 500 ppm by mass or less.

8. The beer-taste wort according to claim 1, wherein a free amino nitrogen content of the beer-taste wort is 40 mg/100 mL or less.

9. The beer-taste wort according to claim 1, wherein a phosphoric acid content of the beer-taste wort is 350 mg/L or more.

10. The beer-taste wort according to claim 1, which is a wort to be diluted by a factor of 2 or more and 10 or less.

11. The beer-taste wort according to claim 1, which is a fermentation wort.

12. The beer-taste wort according to claim 1, comprising no spirits.

13. A beer-taste beverage produced by mixing an edible aqueous solution with the beer-taste wort described in claim 1.
